(19) United States
(12) Patent Application Publication
(10) Pub. No.: US 2007/0165716 A1
(43) Pub. Date: Jul. 19, 2007

(54) Signal processing device, image capturing device, network camera system and video system

(76) Inventors: Shinji Kitamura, Kyoto (JP); Yasuharu Tanaka, Osaka (JP)

Correspondence Address: MCDERMOTT WILL & EMERY LLP, 600 13TH STREET, NW, WASHINGTON, DC, 20005-3096, US

(21) Appl. No.: 11/652,566

(22) Filed: Jan. 12, 2007

(30) Foreign Application Priority Data
Jan. 13, 2006 (JP) 2006-006112

(51) Int. Cl. H04N 7/12; H04N 11/04

(52) U.S. Cl. 375/240.12; 375/240.24

(57) ABSTRACT

A reference image memory comprises seven reference bank memories each having a capacity which can store three reference macroblocks in the vertical direction. Of the seven reference bank memories, any three reference bank memories are adaptively allocated to motion estimation of full pixel precision, any other three reference bank memories are adaptively allocated to motion estimation of half pixel precision, and remaining one reference bank memory is adaptively allocated to spare transfer for image data of a reference macroblock used in motion estimation with respect to the next target macroblock. The reference bank memories are connected to a motion estimating circuit via a total of seven respective buses separately. The motion estimating circuit performs the motion estimation of full pixel precision, the motion estimation of half pixel precision, and the spare transfer for image data of a reference macroblock used in motion estimation with respect to the next target macroblock, in parallel.

### CROSS REFERENCE TO RELATED APPLICATIONS

This Non-provisional application claims priority under 35 U.S.C. §119(a) on Patent Application No. 2006-006112 filed in Japan on Jan. 13, 2006, the entire contents of which are hereby incorporated by reference.

### BACKGROUND OF THE INVENTION

1. Field of the Invention

The present invention relates a signal processing device for estimating a motion vector in motion-compensated predictive coding, which is a moving image compression method, and an image capturing device, a network camera system, and a video system which employ the signal processing device. More particularly, the present invention relates to an improvement in the speed of a motion estimation process and the efficiency of coding.

2. Description of the Related Art

At present, an advanced signal processing technique of compressing an image with a high compression ratio is used in digital cameras or digital camcorders.

As a method of compressing moving images, MPEG (Moving Picture Experts Group) is commonly known. MPEG employs motion-compensated prediction which more efficiently compresses image data by encoding only a displacement of a subject and difference data of an image. In the motion-compensated prediction, a motion vector indicating the displacement of a subject is calculated by a calculation method, such as a block matching method or the like.

Inter-frame predictive coding, in which only previous frame images are used, will be described with reference to FIG. 27. A previous frame image is divided into a number of macroblocks. Several of these macroblocks are designated as reference macroblocks which are referenced so as to estimate a motion vector of a macroblock of interest (also referred to as a target macroblock) in a current frame image. In FIG. 28, a total of nine reference macroblocks, each of which is a block of (x, y)=16 pixels×16 pixels (i.e., 16 pixels in the x direction and 16 pixels in the y direction), are designated as reference macroblocks, and a separation distance between a reference macroblock O after motion compensation and a reference macroblock R positioned at the center of FIG. 28 is calculated as a motion vector M(MVx, MVy).

Hereinafter, a configuration of a motion estimating device for estimating a motion of a macroblock of interest will be described. The configuration is described in, for example, Japanese Unexamined Patent Application Publication No. 2005-210647. FIG. 29 illustrates an internal configuration of the conventional motion estimating device.

In FIG. 29, a motion estimating device 61 comprises a system memory 62, a target image memory 63, and a reference image memory 64. The system memory 62 has a capacity which can store at least a frame image (reference frame image) immediately previous to a current frame image. The target image memory 63 has a capacity which can store pixel data of one macroblock (target macroblock) to be subjected to motion estimation of the current frame image, and pixel data of the next target macroblock to be next subjected. The reference image memory 64 is composed of physically a single memory which is a two-port memory which allows simultaneous data read and write operations. The reference image memory 64 has a capacity of four columns of block areas which can store image data of a total 12 reference macroblocks (three in the length direction and four in the width direction), and is connected to the system memory 62 via a single data bus D1. Each of the target macroblock and the reference macroblock has a size of, for example, (x, y)=16 pixels×16 pixels, as illustrated in FIG. 28.

In FIG. 29, 65 indicates a target image memory control circuit for controlling the target image memory 63, 66 indicates a reference image memory control circuit for controlling the reference image memory 64, and 67 indicates a system memory control circuit for controlling the system memory 62 in accordance with a control signal from the reference image memory control circuit 66. Further, 68 indicates a motion estimating circuit which is connected to the target image memory 63 and the reference image memory 64 via buses D2 and D3, respectively, and controls the target image memory control circuit 65 and the reference image memory control circuit 66 to transfer the image data of a target macroblock and the next target macroblock to the target image memory 63, and successively transfer a plurality of reference macroblocks from the system memory 62 to the reference image memory 64. The motion estimating circuit 68 also reads the image data of the target macroblock transferred to the target image memory 63 and the image data of the reference macroblocks transferred to the reference image memory 64, performs motion estimation with respect to the target macroblock while referencing the reference macroblocks, and outputs a motion vector M(MVX, MVy) and image data of the reference macroblocks after motion compensation.

Next, an operation of the motion estimating device 61 of FIG. 29 will be described with reference to FIG. 30. Note that, for the sake of simplicity, as illustrated in FIG. 30, a frame is assumed to be composed of (x, y)=5×3 macroblocks (=80 pixels×48 pixels), and a search range for motion estimation is assumed to be composed of (x, y)=3×3 macroblocks. In this description, as indicated by numbers shown in FIG. 30, a reference macroblock having a number n (n=0 to 14) is represented by a reference macroblock “n”, and a target macroblock having a number n is represented by a target macroblock “n”.

In FIG. 30, in step 1, image data of a target macroblock “0” is input to the target image memory 63. At the same time, four reference macroblocks “0”, “1”, “5” and “6” located at the same position as that of and around the target macroblock “0” are transferred from the system memory 62 and stored into block areas on the second and third columns of the reference image memory 64.

Next, in step 2, the image data of the target macroblock “0” in the target image memory 63 is output to the motion estimating circuit 68, and image data of the reference macroblocks “0”, “1”,“5” and “6” in the reference image memory 64 are output to the motion estimating circuit 68, and thereafter, motion estimation is performed with respect to the target macroblock “0”. In parallel to this, image data of the next target macroblock “1” is stored into the target image memory 63, and reference macroblocks “2” and “7” other than the reference macroblocks which have already been stored of the reference macroblocks “0” to “2” and “5” to “7” located around the next target macroblock “1” are transferred from the system memory 62 and stored into block areas in the fourth column of the reference image memory 64, which is preparation for motion estimation with respect to the next target macroblock “1”. Here, in the reference image memory 64, reading of image data from the second- and third-column block areas and writing of image data into the fourth-column block area are simultaneously performed. This is possible because these read and write operations are performed with respect to block areas on different columns, and the reference image memory 64 is of the two port type which allows reading and writing to be performed in parallel.

When motion estimation is finished with respect to the target macroblock “0”, the operation goes to step 3. In step 3, as is similar to that described above, the image data of the next target macroblock “1” and the image data of the reference macroblocks “0” to “2” and “5” to “7” are output to the motion estimating circuit 68, and motion estimation is performed with respect to the target macroblock “1”, and thereafter, while image data of the next target macroblock “2” is stored into the target image memory 63, reference macroblocks “3” and “8” other than the reference macroblocks which have already been stored of the reference macroblocks “1” to “3” and “6” to “8” located at the same position as that of and around the next target macroblock “2” are transferred from the system memory 62 and stored into the first-column block area of the reference image memory 64.

Next, when motion estimation is finished with respect to the target macroblock “1”, the operation goes to step 4. In step 4, as is similar to that described above, motion estimation is performed with respect to the target macroblock “2” while referencing the image data of the reference macroblocks “1” to “3” and “6” to “8”, and while image data of the next target macroblock “3” is stored into the target image memory 63, reference macroblocks “4” and “9” which are to be referenced in motion estimation with respect to the next target macroblock “3” are newly transferred from the system memory 62 and stored into the second-column block area of the reference image memory 64.

Thereafter, when motion estimation is finished with respect to the target macroblock “2”, the operation goes to step 5. In step 5, as is similar to that described above, motion estimation is performed with respect to the target macroblock “3” while the image data of the reference macroblocks “2” to “4” and “7” to “9” are referenced, and while image data of the next target macroblock “5” is stored into the target image memory 63, image data of three reference macroblocks “0”, “5” and “10” which are to be referenced in motion estimation with respect to the next target macroblock “5” are newly transferred from the system memory 62 and stored into the third-column block area of the reference image memory 64.

An operation similar to that described above is thereafter repeatedly performed to perform motion estimation with respect to blocks “4” to “14”. In the above-described operation, it is not necessary to repeatedly transfer the image data of the same reference macroblock from the system memory 62 to the reference image memory 64, thereby making it possible to perform motion estimation with respect to each target macroblock with high efficiency.

In motion-compensated predictive coding, motion estimation as described above is called “motion estimation of full pixel precision”, and in order to increase the precision of the “motion estimation of full pixel precision”, “motion estimation of half pixel precision” is employed. The motion estimation of half pixel precision is performed as follows. As illustrated in FIG. 31, regarding full pixel precision reference image data which is motion-compensated using the motion vector M(MVx, MVy) obtained by motion estimation as described above (the positions of the image data are indicated by hatched circles), two pieces of image data adjacent to each other vertically or horizontally are subjected to a filtering process to generate image data located between these pieces of image data. By repeatedly performing this process, image data having half pixel precision (positions of the image data are indicated by open circles in FIG. 31), and for example, the position of the tip end of a motion vector M is changed from full pixel precision image data P to any one of eight pieces of surrounding half pixel precision image data a to h, thereby further improving the precision of motion estimation.

However, the above-described conventional motion estimating device has the following drawbacks.

Specifically, when motion estimation of half pixel precision is performed in addition to motion estimation of full pixel precision as described above, motion estimation of full pixel precision is initially performed, and thereafter, a portion of image data of a plurality of reference macroblocks which has been used in the motion estimation of full pixel precision needs to be used again in motion estimation of half pixel precision. Therefore, as illustrated in FIGS. 32A and 32B, when only motion estimation of full pixel precision is performed, one time slot may have a predetermined time as illustrated in 32A. However, when motion estimation of half pixel precision is additionally performed, motion estimation of half pixel precision needs to be performed continuously after the motion estimation of full pixel precision, and one time slot required needs to be set to be longer than in motion estimation of full pixel precision. As a result, although the precision of motion estimation is improved, it disadvantageously takes a longer time to perform motion estimation.

Also, in the above-described conventional motion estimation, the reference image memory 64 comprises four columns of block areas, each of which corresponds to three reference macroblocks as described above, and three of the four columns of block areas are allocated to motion estimation with respect to a target macroblock, and the remaining one column of block areas is allocated to preparation of motion estimation with respect to the next target macroblock. Thus, the four columns of block areas in the reference image memory 64 are invariably used. Therefore, even when the motion of an image is significant, a search range for motion estimation is fixedly narrow, so that precise motion estimation cannot be achieved.

### SUMMARY OF THE INVENTION

An object of the present invention is to provide parallel processing of motion estimation of full pixel precision and motion estimation of half pixel precision, and high-precision motion estimation irrespective of a significant motion.

To achieve the object, the present invention provides a configuration of a reference image memory and a connection relationship between a reference image memory and a motion estimating circuit which allow both motion estimation of full pixel precision and motion estimation of half pixel precision to be performed in parallel, and allows a search range for motion estimation to be variably set.

Specifically, the present invention provides a signal processing device for estimating a motion of a target macroblock image included in a target frame image by referencing a plurality of reference macroblock images included in a reference frame image, comprising a target image storing section for storing the target macroblock image included in the target frame image, a reference image storing section for storing a plurality of reference macroblock images located in a first direction which is a direction in which the target macroblock image is processed and in a second direction perpendicular to the first direction around a reference macroblock image corresponding to the target macroblock image of the plurality of reference macroblock images included in the reference frame image, and having a plurality of reference bank sections which are physically separately divided areas each including a predetermined number of reference macroblock images located in the second direction, and a motion estimating section for performing motion estimation with respect to the target macroblock image in the target image storing section by referencing the plurality of reference macroblocks stored in the plurality of reference bank sections of the reference image storing section.

In one example of the signal processing device of the present invention, the plurality of reference bank sections of the reference image storing section are adaptively allocated to at least a full pixel precision reference bank section for storing a plurality of reference macroblock images for performing motion estimation of full pixel precision with respect to a target macroblock image, a spare transfer reference bank section for storing a plurality of reference macroblock images for the next cycle for performing motion estimation with respect to a target macroblock image in the next cycle of the target macroblock image, and a half pixel precision reference bank section for storing a plurality of reference macroblock images for performing motion estimation of half pixel precision with respect to a target macroblock image a predetermined number of cycles before the target macroblock image. All of the reference bank sections included in the reference image storing section and the motion estimating section are connected via respective separate signal lines.

In one example of the signal processing device of the present invention, the signal processing device further comprises a transfer control section for controlling transfer of the plurality of reference macroblock images stored in the plurality of reference bank sections of the reference image storing section. The transfer control section performs a full/half pixel precision search parallel execution control to store the plurality of reference macroblock images for the next cycle into the spare transfer reference bank section while simultaneously transferring the plurality of reference macroblock images stored in the full pixel precision reference bank section and the plurality of reference macroblock images stored in the half pixel precision reference bank section to the motion estimating section.

In one example of the signal processing device of the present invention, instead of the full/half pixel precision search parallel execution control, the transfer control section performs a full/half pixel precision search serial execution control to store the plurality of reference macroblock images for the next cycle into the spare transfer reference bank section, and thereafter, transfer the plurality of reference macroblock images stored in the full pixel precision reference bank section as a plurality of reference macroblock images for half pixel precision to the motion estimating section, while transferring the plurality of reference macroblock images stored in the full pixel precision reference bank section to the motion estimating section.

In one example of the signal processing device of the present invention, the signal processing device further comprises a bank configuration specifying section for specifying the number of reference bank sections used in the reference image storing section as a bank configuration. The bank configuration specifying section receives information about required image performance, and changes the bank configuration of the reference image storing section, depending on the received required performance. The transfer control section switches the full/half pixel precision search parallel execution control and the full/half pixel precision search serial execution control, depending on the bank configuration of the reference image storing section changed by the bank configuration specifying section.

In one example of the signal processing device of the present invention, the signal processing device further comprises a bank configuration specifying section for specifying the number of reference bank sections used in the reference image storing section as a bank configuration. The bank configuration specifying section receives information about required image performance, and changes the bank configuration of the reference image storing section, depending on the received required performance, and when the received required performance is high, enlarges storage areas of the full pixel precision reference bank section, the spare transfer reference bank section, and the half pixel precision reference bank section.

In one example of the signal processing device of the present invention, the information about required image performance is image quality of an image.

In one example of the signal processing device of the present invention, the information about required image performance is a size of an image.

In one example of the signal processing device of the present invention, the information about required image performance is a frame rate of an image.

In one example of the signal processing device of the present invention, motion estimation of an image is performed with bidirectional prediction. The full pixel precision reference bank section, the spare transfer reference bank section, and the half pixel precision reference bank section of the reference image storing section are separated into forward prediction-dedicated sections and backward prediction-dedicated sections. Reference macroblock images are transferred to the motion estimating section from the forward prediction-dedicated full pixel precision reference bank section, spare transfer reference bank section and half pixel precision reference bank section, and the backward prediction-dedicated full pixel precision reference bank section, spare transfer reference bank section and half pixel precision reference bank section.

In one example of the signal processing device of the present invention, the signal processing device further comprises a prediction precision detecting section for detecting prediction precision of motion estimation in a set range of an image by the motion estimating section, and a bank configuration specifying section for specifying the number of reference bank sections used in the reference image storing section as a bank configuration. The bank configuration specifying section changes the bank configuration of the reference image storing section, depending on the prediction precision detected by the prediction precision detecting section, and when the prediction precision is low, increases the number of reference bank sections to be used.

In one example of the signal processing device of the present invention, the set range of an image is one frame of the image.

In one example of the signal processing device of the present invention, depending on prediction precision in one frame of an image detected by the prediction precision detecting section, the bank configuration specifying section changes the number of reference bank sections in the reference image storing section to be used in motion estimation with respect to a frame next to the frame in which the prediction precision has been detected.

In one example of the signal processing device of the present invention, the set range of an image is one block line in one frame of the image including a plurality of block lines located in the second direction, each block line including a plurality of macroblocks located in the first direction.

In one example of the signal processing device of the present invention, depending on prediction precision in one block line of an image detected by the prediction precision detecting section, the bank configuration specifying section changes the number of reference bank sections in the reference image storing section to be used in motion estimation with respect to a block line next to the block line in which the prediction precision has been detected.

In one example of the signal processing device of the present invention, the motion estimating section calculates a motion vector for each target macroblock image. The signal processing device further comprises a comparison section for comparing the motion vector for each target macroblock image in the set range of an image by the motion estimating section with a reference value, and a bank configuration specifying section for specifying the number of reference bank sections used in the reference image storing section as a bank configuration. The bank configuration specifying section changes the bank configuration of the reference image storing section, depending on a result of the comparison in the comparison section.

In one example of the signal processing device of the present invention, the comparison section counts the number of motion vectors for target macroblock images exceeding the reference value. The bank configuration specifying section, when the count value is larger than or equal to a set value, increases the number of reference bank sections used in the reference image storing section.

In one example of the signal processing device of the present invention, the set range of an image is one frame of the image.

In one example of the signal processing device of the present invention, the bank configuration specifying section changes the number of reference bank sections in the reference image storing section to be used in motion estimation with respect to a frame next to the frame including the target macroblock in which the motion vector has been detected, depending on a result of the comparison by the comparison section.

In one example of the signal processing device of the present invention, the set range of an image is one block line in one frame of the image including a plurality of block lines located in the second direction, each block line including a plurality of macroblocks located in the first direction.

In one example of the signal processing device of the present invention, depending on a result of the comparison by the comparison section, the bank configuration specifying section changes the number of reference bank sections in the reference image storing section to be used in motion estimation with respect to a block line next to the block line including the target macroblock in which the motion vector has been detected.

In one example of the signal processing device of the present invention, the comparison section compares the first direction component and the second direction component of a motion vector of each target macroblock image with a first direction reference value and a second direction reference value, respectively. The bank configuration specifying section changes the bank configuration of the reference image storing section, depending on a result of the comparison of the first direction and the second direction in the comparison section.

In one example of the signal processing device of the present invention, the signal processing device further comprises a bank configuration specifying section for specifying the number of reference bank sections used in the reference image storing section as a bank configuration.

The present invention also provides an image capturing device comprising the above-described signal processing device, and an image capturing section for capturing a moving image, and outputting the image signal to the signal processing device. The image capturing section has a change detecting section for detecting a change in image position when the moving image is captured. A portion of the bank configuration specifying section included in the signal processing device is also used as the change detecting section included in the image capturing section.

The present invention also provides a network system comprising a network camera having an image capturing section, and a plurality of image terminals for requesting distribution of a moving image captured by the image capturing section of the network camera, and each having an image display device for displaying the distributed moving image. The network camera has the above-described signal processing device. The bank configuration specifying section included in the signal processing device changes the bank configuration of the reference image storing section, depending on the number of the image terminals which simultaneously issue the request for distribution of the moving image.

In one example of the network camera system of the present invention, the signal processing device has the transfer control section. The transfer control section invariably performs the full/half pixel precision search parallel execution control using the bank configuration of the reference image storing section changed by the bank configuration specifying section.

In one example of the network camera system of the present invention, the signal processing device has the transfer control section. The transfer control section switches and controls the full/half pixel precision search parallel execution control and the full/half pixel precision search serial execution control, depending on the bank configuration of the reference image storing section changed by the bank configuration specifying section.

In one example of the network camera system of the present invention, assuming that while the moving image is distributed to any of the plurality of image terminals, there is a request for distribution of a moving image from another image terminal, when the bank configuration specifying section cannot change the bank configuration of the reference image storing section in response to the request for distribution of the moving image from the other image terminal, the network camera notifies the other image terminal issuing the distribution request of that matter.

In one example of the network camera system of the present invention, the other image terminal issuing the distribution request, when receiving from the network camera the notification indicating that the bank configuration of the reference image storing section cannot be changed, transmits to the network camera a request for distribution in which required performance of the moving image is lowered. The bank configuration specifying section of the signal processing device of the network camera, when receiving from the other image terminal the request for distribution in which the required performance of the moving image is lowered, tries to change the bank configuration of the reference image storing section, depending on the required performance.

In one example of the network camera system of the present invention, when the bank configuration specifying section cannot change the bank configuration of the reference image storing section, depending on the request for distribution of the moving image from the other image terminal, the network camera notifies the image terminal which is distributing the moving image of an inquiry of whether or not allocation of the reference bank section to the other image terminal issuing the distribution request with priority is permitted.

In one example of the network camera system of the present invention, the image terminal which is distributing the moving image responds to the network camera, regarding the inquiry of whether or not allocation of the reference bank section to the other image terminal issuing the distribution request with priority is permitted. The network camera performs the priority allocation when receiving, from image terminal which is distributing the moving image, a response which permits the allocation of the reference bank section to the other image terminal issuing the distribution request with priority.

The present invention also provides a video system comprising an image processing section including the above-described signal processing device and for performing image processing, a sensor for outputting an image signal to the signal processing device of the image processing section, and an optical system for imaging light onto the sensor.

The present invention also provides a video system comprising an image processing section including the above-described signal processing device and for performing image processing, and an A/D conversion section for receiving an image signal having an analog value, converting the image signal into a digital value, and outputting the digital value to the signal processing device of the image processing section.

The present invention also provides a signal processing method for estimating a motion of a target macroblock image included in a target frame image by referencing a plurality of reference macroblock images included in a reference frame image. The motion estimation includes first motion estimation for estimating a motion of the target macroblock image in units of a full pixel, and second motion estimation for estimating a motion of the target macroblock image in units of a half pixel. The signal processing method comprises a first step of performing the first motion estimation, and a second step of performing the second motion estimation. The first step and the second step are performed in parallel.

The present invention also provides a signal processing device for estimating a motion of a target macroblock image included in a target frame image by referencing a plurality of reference macroblock images included in a reference frame image. The motion estimation includes first motion estimation for estimating a motion of the target macroblock image in units of a full pixel, and second motion estimation for estimating a motion of the target macroblock image in units of a half pixel. The signal processing device comprises a reference image storing section for storing a plurality of reference macroblock images located in a horizontal direction and a vertical direction around a reference macroblock image corresponding to the target macroblock image of the plurality of reference macroblock images included in the reference frame image, and a motion estimating section for performing the first motion estimation and the second motion estimation by referencing the plurality of reference macroblocks stored in the reference image storing section. The first motion estimation and the second motion estimation are performed in parallel in the motion estimating section.

In one example of the signal processing device of the present invention, the reference image storing section is a built-in memory provided in the signal processing device.

In one example of the signal processing device of the present invention, the built-in memory is an SRAM.

In one example of the signal processing device of the present invention, when a search range for motion estimation includes n reference image macroblocks in a processing direction, the first motion estimation with respect to an (m+n)-th macroblock and the second motion estimation with respect to an m-th macroblock are performed in parallel.

As described above, in the signal processing device of the present invention, the reference image storing section comprises the physically separately divided reference bank sections. These reference bank sections are adaptively allocated to motion estimation of full pixel precision, motion estimation of half pixel precision, and spare transfer. The reference macroblocks of the reference bank sections are transferred to the motion estimating section via the respective separate signal lines. Thereby, the motion estimating section utilizes the full pixel precision reference macroblock and the half pixel precision reference macroblock to perform motion estimation of full pixel precision and motion estimation of half pixel precision in parallel. Therefore, motion estimation can be performed with high speed and high precision as compared to when motion estimation of full pixel precision and motion estimation of half pixel precision are performed in series.

Here, after image data of reference macroblocks stored in a reference bank section allocated to full pixel precision is used to perform motion estimation of full pixel precision, the image data of the reference macroblocks is held as it is. After several cycles, when the image data is no longer used for motion estimation of full pixel precision with respect to a target macroblock, the reference bank section allocated to full pixel precision is caused to function as a half pixel precision reference bank section. If the image data of reference macroblocks stored in the reference bank section is transferred to the motion estimating section for motion estimation of half pixel precision, the image data of the same reference macroblock does not need to be repeatedly written into the reference image storing section.

Further, in the signal processing device of the present invention, the bank configuration of the reference image storing section is changed, depending on the prediction precision of motion estimation or the magnitude of a motion vector. Therefore, when a motion of an image is significant, a search range for motion estimation can be enlarged, whereby a high precision of motion estimation can be invariably achieved, resulting in an increase in coding efficiency.

Furthermore, in the image capturing device of the present invention, a change in image position when a moving image is captured is detected by the change detecting section of the image capturing section. Using the image position change detected by the change detecting section, the bank configuration specifying section of the signal processing device changes the bank configuration of the reference image storing section, whereby a change detecting section does not need to be separately added to the signal processing device.

In addition, in the network camera system of the present invention, the above-described signal processing device is provided. Therefore, parallel process of motion estimation of full pixel precision and motion estimation of half pixel precision, and serial processing of motion estimation of full pixel precision and motion estimation of half pixel precision, can be adaptively switched, and a search range for motion estimation can be enlarged and reduced, depending on a motion of an image, whereby high coding efficiency is invariably obtained.

### BRIEF DESCRIPTION OF THE DRAWINGS

FIG. 1 is a diagram illustrating a schematic whole configuration of a signal processing device according to a first example of the present invention.

FIG. 2 is a diagram for describing an operation of the motion estimating device of FIG. 1.

FIG. 3A is a diagram for describing parallel processing of motion estimation of full pixel precision and motion estimation of half pixel precision. FIG. 3B is a diagram for describing serial processing of motion estimation of full pixel precision and motion estimation of half pixel precision. FIG. 3C is a diagram for describing an operation in which only motion estimation of full pixel precision is performed.

FIGS. 4A and 4B are diagrams illustrating schematic whole configuration of image motion estimating devices which are signal processing devices according to a second example of the present invention. FIG. 4A is a diagram when different reference bank memories are used to perform motion estimation of full pixel precision and motion estimation of half pixel precision in parallel. FIG. 4B is a diagram when the same reference bank memory is used to perform motion estimation of full pixel precision and motion estimation of half pixel precision in series.

FIGS. 5A and 5B are diagrams illustrating schematic whole configuration of image motion estimating devices which are signal processing devices according to a third example of the present invention. FIG. 5A is a diagram illustrating allocation of banks in a reference image memory when a search range is set to be an initial range. FIG. SB is a diagram illustrating allocation of banks in a reference image memory when a search range is set to be an enlarged range.

FIG. 6 is a diagram for describing bidirectional prediction in which forward prediction and backward prediction are used in motion-compensated prediction of MPEG.

FIGS. 7A and 7B are diagrams illustrating schematic whole configuration of image motion estimating devices which are signal processing devices according to a fourth example of the present invention. FIG. 7A is a diagram illustrating allocation of banks in a reference image memory in a coding method employing only forward prediction. FIG. 7B is a diagram illustrating allocation of banks in a reference image memory in a coding method employing bidirectional prediction.

FIG. 8 is a diagram illustrating a schematic whole configuration of an image motion estimating device which is a signal processing devices according to a fifth example of the present invention.

FIGS. 9A and 9B are diagrams illustrating bank allocation of a reference image memory in the motion estimating device of FIG. 8. FIG. 9A is a diagram when a search range is set to be a normal range. FIG. 9B is a diagram when a search range is set to be an enlarged range.

FIG. 10 is a control flowchart of a motion estimation operation in the motion estimating device of FIG. 8.

FIG. 11 is a control flowchart illustrating a motion estimation operation of an image motion estimating device which is a signal processing device according to a sixth example of the present invention.

FIG. 12 is a diagram illustrating a schematic whole configuration of an image motion estimating device which is a signal processing device according to a seventh example of the present invention.

FIG. 13 is a control flowchart of a motion estimation operation in the motion estimating device of FIG. 12.

FIG. 14 is a control flowchart illustrating a motion estimation operation of an image motion estimating device which is a signal processing device according to an eighth example of the present invention.

FIG. 15 is a diagram illustrating a schematic whole configuration of an image motion estimating device which is a signal processing device according to a ninth example of the present invention.

FIG. 16 is a control flowchart of a motion estimation operation in the motion estimating device of FIG. 15.

FIGS. 17A to 17D are diagrams illustrating bank allocation of a reference image memory in the motion estimating device of FIG. 15. FIG. 17A is a diagram when a search range is set to be a normal range. FIG. 17B is a diagram when a search range is enlarged in the horizontal and vertical directions. FIG. 17C is a diagram when a search range is enlarged only in the horizontal direction. FIG. 17D is a diagram when a search range is enlarged only in the vertical direction.

FIG. 18 is a diagram illustrating a schematic whole configuration of an image motion estimating device which is a signal processing device according to a tenth example of the present invention.

FIG. 19 is a diagram illustrating a schematic whole configuration of a network camera including an image motion estimating device which is a signal processing device according to an eleventh example of the present invention.

FIG. 20 is a diagram illustrating a relationship between the number of channels to be coded and a request processing speed in the network camera of FIG. 19.

FIG. 21 is a diagram illustrating a schematic whole configuration of the motion estimating device of the eleventh example.

FIGS. 22A to 22D are diagrams illustrating bank allocation of a reference image memory in the motion estimating device of FIG. 19. FIG. 22A is a diagram when the number of channels is 1. FIG. 22B is a diagram when the number of channels is 2. FIG. 22C is a diagram when the number of channels is 3. FIG. 22D is a diagram when the number of channels is 4.

FIG. 23 is a diagram illustrating a schematic whole configuration of a network camera including an image motion estimating device which is a signal processing device according to a twelfth example of the present invention.

FIG. 24 is a state transition diagram illustrating state transition of control states in the network camera of FIG. 23, including a state in which a notification is issued to a requesting client.

FIG. 25 is a state transition diagram illustrating state transition of control states in the network camera of FIG. 23, including a state in which a notification is issued to another client.

FIG. 26 is a diagram illustrating a schematic whole configuration of an image capturing system including an image motion estimating device which is a signal processing device according to a thirteenth example of the present invention.

FIG. 27 is a diagram illustrating a sequence of inter-frame predictive coding.

FIG. 28 is a diagram illustrating the concept of a motion search of full pixel precision.

FIG. 29 is a diagram illustrating a schematic whole configuration of a conventional image motion estimating device.

FIG. 30 is a diagram for describing the conventional image motion estimating device of FIG. 29.

FIG. 31 is a diagram illustrating the concept of a motion search of half pixel precision.

FIGS. 32A and 32B are diagrams illustrating timing of a motion estimation process in the conventional image motion estimating device of FIG. 29. FIG. 29A is a diagram for describing an operation in which only motion estimation of full pixel precision is performed. FIG. 29B is a diagram for describing an operation in which motion estimation of full pixel precision and motion estimation of half pixel precision are performed in series.

### DETAILED DESCRIPTION OF THE PREFERRED EMBODIMENTS

Hereinafter, preferred examples of the present invention will be described with reference to the accompanying drawings.

### FIRST EXAMPLE

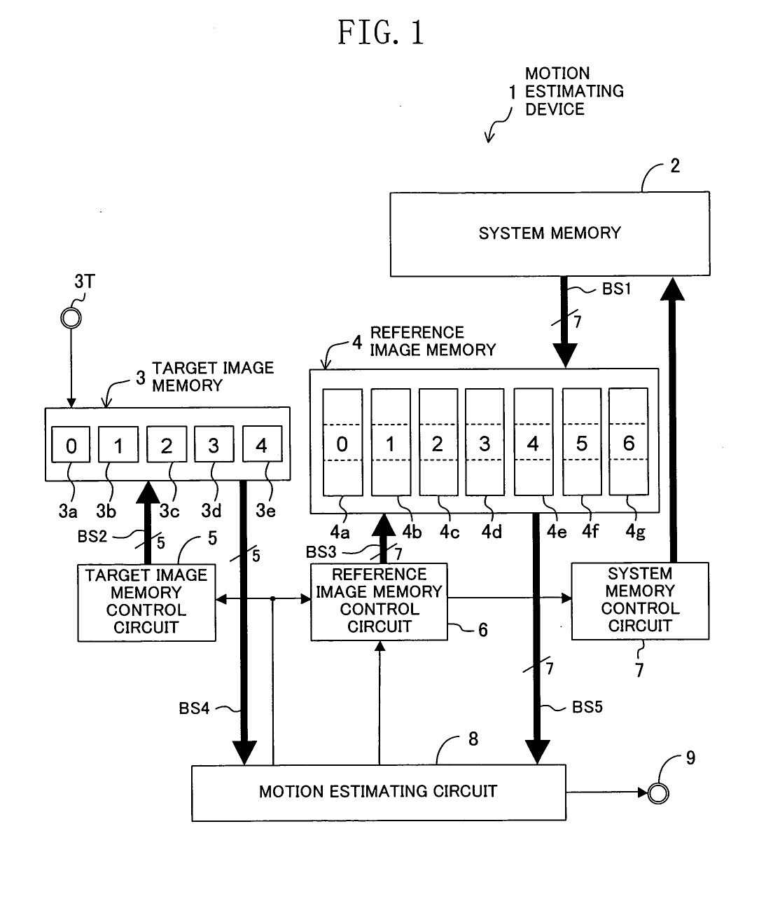

FIG. 1 illustrates a schematic whole configuration of a signal processing device according to an example of the present invention. The signal processing device of FIG. 1 is a device for estimating a motion in an image.

In the motion estimating device 1 of FIG. 1, 2 indicates a system memory, 3 indicates a target image memory, and 4 indicates a reference image memory. The system memory 2 has a capacity which can store at least one frame image. The target image memory (target image storing section) 3 successively receives pixel data of one macroblock which is a target of motion estimation (hereinafter referred to as a target macroblock) from a terminal 3T, and comprises five physically separate one-port target block memories 3a to 3e. Here, for example, a macroblock refers to a block of (x, y)=16 pixels×16 pixels as illustrated in FIG. 28. For example, image data including 8×8 macroblocks (i.e., 8 in the width direction and 8 in the length direction) constitute a frame image (=128 pixels×128 pixels). A frame image stored in the system memory 2 is image data of one reference frame image which is referenced in motion estimation with respect to a target macroblock stored in the target image memory 4. Hereinafter, 64 macroblocks constituting the reference frame image are referred to as reference macroblocks.

The reference image memory (reference image storing section) 4 comprises physically separate reference bank memories (reference bank sections) 4a to 4g including seven respective one-port SRAMs. The reference bank memories 4a to 4g each have a capacity which can store image data of (x, y)=1×3 macroblocks, and are separately connected to the system memory 2 via seven respective buses BS1. Image data of three reference macroblocks can be supplied form the system memory 2 to each of the reference bank memories 4a to 4g separately. Of the seven reference bank memories 4a to 4g, any three reference bank memories are allocated to full pixel precision, any other three reference bank memories are allocated to half pixel precision, and the remaining one reference bank memory is allocated to spare transfer. The way of allocating the seven reference bank memories to full pixel precision, half pixel precision, and spare transfer is adaptively changed every a cycle as described below (where the operation is described).

Also, in FIG. 1, 5 indicates a target image memory control circuit, 6 indicates a reference image memory control circuit, 7 indicates a system memory control circuit, and 8 indicates a motion estimating circuit (motion estimating section). The target image memory control circuit 5 are connected to the five target block memories 3a to 3e in the target image memory 3 via five buses BS2, and controls the target block memories 3a to 3e separately so that image data of a target macroblock is input from the terminal 3T to any one of the five target block memories 3a to 3e in the target image memory 3. The reference image memory control circuit 6 is connected to the seven reference bank memories 4a to 4g in the reference image memory 4 via seven buses BS3, and controls the reference bank memories 4a to 4g separately so that image data of three reference macroblocks is transferred from the system memory 2 to any one of the seven reference bank memories 4a to 4g in the reference image memory 4. Also, when the reference macroblock input from the system memory 2 is the last reference macroblock in a frame image, the reference image memory control circuit 6 outputs a control signal to the system memory control circuit 7. When receiving the control signal from the reference image memory control circuit 6, the system memory control circuit 7 switches a reference frame which is read from the system memory 2 to the next frame.

Further, the motion estimating circuit 8 is connected to the five target block memories 3a to 3e in the target image memory 3 via five buses BS4, and is connected to the seven reference bank memories 4a to 4g separately in the reference image memory 4 via seven buses (signal lines) BS5. Further, the motion estimating circuit 8 controls the target image memory control circuit 5 and the reference image memory control circuit 6 so that image data of target macroblocks from the five target block memories 3a to 3e in the target image memory 3 and image data of reference macroblocks from the seven reference bank memories 4a to 4g in the reference image memory 4 are separately transferred to itself (the motion estimating circuit 8) (i.e., the motion estimating circuit 8 also serves as a transfer control section), and performs a full/half pixel precision search parallel execution control. The full/half pixel precision search parallel execution control is a control in which, as described in detail below (where the operation is described), while image data of a plurality of reference macroblocks stored in a reference bank memory allocated to full pixel precision, and image data of a plurality of reference macroblocks stored in a reference bank memory for half pixel precision, are simultaneously transferred into the motion estimating circuit 8, image data of a plurality of reference macroblocks used for motion estimation with respect to the next target macroblock is transferred from the system memory 2 to a reference bank memory allocated to spare transfer. The motion estimating circuit 8 simultaneously performs motion estimation of full pixel precision with respect to a target macroblock, and motion estimation of half pixel precision with respect to a target macroblock which has been subjected to motion estimation of full pixel precision, by the full/half pixel precision search parallel execution control, and outputs image data of the motion-compensated reference macroblock from an output terminal 9.

A subsequent process for a motion vector and image data of an optimal reference macroblock detected by the motion estimating circuit 8 will be roughly described as follows. The motion vector and the image data of the optimal reference macroblock thus obtained are transferred to a motion compensating section (not shown), in which generates a predicted image. Thereafter, a difference between the predicted image and an input image is calculated. This prediction error is converted into a DCT coefficient by a DCT section (not shown). The DCT coefficient is quantized. The quantized DCT coefficient and the motion vector are converted into a variable-length code, which is in turn output as a bitstream. The DCT coefficient is subjected to inverse quantization and inverse DCT to obtain prediction error data. The prediction error data is added to the predicted image to obtain a previous frame image. The previous frame image is stored into the system memory 2.

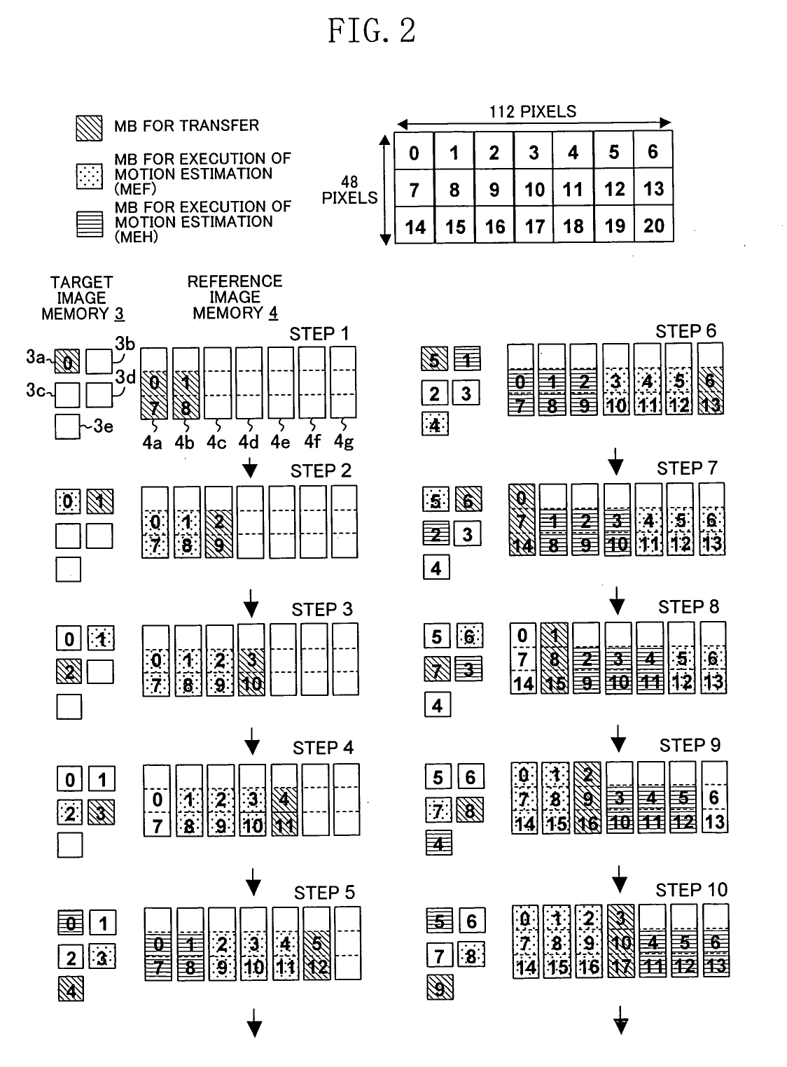

Next, motion estimation of full pixel precision and motion estimation of half pixel precision performed by the three control circuits 5 to 7 and the motion estimating circuit 8 will be specifically described with reference to FIG. 2. Note that, for the sake of simplicity, as illustrated in FIG. 2, a range of (x, y)=7×3 macroblocks (=112 pixels×48 pixels) is defined as one frame, and a range of (x, y)=3×3 macroblocks is defined as a search range for motion estimation. In this description, as illustrated in FIG. 2, a reference macroblock having a number n (n=0 to 20) is represented by a reference macroblock “n”, and a target macroblock having a number n is represented by a target macroblock “n”.

In FIG. 2, in step 1, image data of a target macroblock “0” is input to the target block memory 3a of the target image memory 3. At the same time, of reference macroblocks “0”, “1”, “7” and “8” located at the same position as that of and around the target macroblock “0”, two reference macroblock “0” and “7” located in the vertical direction are transferred from the system memory 2 and stored into the reference bank memory 4a of the reference image memory 4, and remaining two reference macroblocks “1” and “8” located in the vertical direction are stored into the reference bank memory 4b of the reference image memory 4. Therefore, in step 1, the reference bank memories 4a and 4b are allocated to full pixel precision.

Thereafter, in step 2, the image data of the target macroblock “0” in the target block memory 3a is output to the motion estimating circuit 8, and the image data of the reference macroblocks “0”, “1”, “7” and “8” in the reference bank memories 4a and 4b are output to the motion estimating circuit 8, and thereafter, motion estimation of full pixel precision is performed with respect to the target macroblock “0”. In parallel to this, image data of the target macroblock “1” is stored into the target block memory 3b of the target image memory 3, and of reference macroblocks “0” to “2” and “7” to “9” located at the same position as that of and around the target macroblock “1”, the reference macroblocks “2” and “9” other than the reference macroblocks which have already been stored are transferred from the system memory 2 and stored into the reference bank memory 4c of the reference image memory 4 for preparation for motion estimation of the next target macroblock “1”. Therefore, in step 2, the reference bank memory 4c is allocated to spare transfer.

Next, in step 3, as is similar to that described above, the image data of the target macroblock “1” and the image data of the reference macroblocks “0” to “2” and “7” to “9” are output to the motion estimating circuit 8, and thereafter, motion estimation of full pixel precision is performed with respect to the target macroblock “1”, and while image data of the next target macroblock “2” is stored into the target block memory 3c of the target image memory 3, reference macroblocks “3” and “10” other than the reference macroblocks which have already been stored of reference macroblocks “1” to “3” and “8” to “10” located at the same position as that of and around the target macroblock “2” are transferred from the system memory 2 and stored into the reference bank memory 4d of the reference image memory 4.

Next, in step 4, motion estimation of full pixel precision is performed with respect to the target macroblock “2” while referencing image data of the reference macroblocks “1” to “3” and “8” to “10”, and while image data of the next target macroblock “3” is stored into the target block memory 3d of the target image memory 3, reference macroblocks “4” and “11” which are to be referenced in motion estimation of the target macroblock are newly transferred from the system memory 2 and stored into the reference bank memory 4e of the reference image memory 4. At this time point, the image data of the reference macroblocks “0” and “7” in the vertical direction stored in the reference bank memory 4a of the reference image memory 4 are held as they are.

Thereafter, in step 5, motion estimation of full pixel precision is performed with respect to the target macroblock “3” while referencing image data of the reference macroblocks “2” to “4” and “9” to “11”, and while image data of the next target macroblock “4” is stored into the target block memory 3e of the target image memory 3, image data of reference macroblocks “5” and “12” which are to be referenced in motion estimation with respect to the target macroblock is transferred from the system memory 2 and stored into the reference bank memory 4f of the reference image memory 4. Therefore, in step 5, the reference bank memories 4c to 4e are allocated to motion estimation of full pixel precision, and the reference bank memory 4f is allocated to spare transfer. At this time point, the four reference macroblocks “0”, “1”, “7” and “8” stored in the reference bank memories 4a and 4b of the reference image memory 4, i.e., reference macroblocks used for motion estimation of half pixel precision with respect to the target macroblock “0”, are image data which is not used for motion estimation of full pixel precision with respect to the target macroblock “3”. Therefore, while motion estimation of full pixel precision is performed with respect to the target macroblock “3”, the image data of the target macroblock “0” in the target block memory 3a of the target image memory 3 and the image data of the four reference macroblocks “0”, “1”, “7” and “8” stored in the reference bank memories 4a and 4b of the reference image memory 4 are output together to the motion estimating circuit 8, and thereafter, motion estimation of half pixel precision is performed with respect to the target macroblock “0”. Therefore, in step 5, the reference bank memories 4a and 4b are allocated to half pixel precision, which is changed from full pixel precision. Thus, in step 5, motion estimation of full pixel precision with respect to the target macroblock “3”, and motion estimation of half pixel precision with respect to the target macroblock “0” using the reference macroblocks “0”, “1”, “7” and “8” which are not used in motion estimation of full pixel precision, are simultaneously performed. Here, since motion estimation of full pixel precision and motion estimation of half pixel precision are simultaneously performed, image data are simultaneously output from the reference bank memories 4c to 4e and 4a and 4b of the reference image memory 4 to the motion estimating circuit 8. In this case, since the reference bank memories 4a to 4g are connected via the respective dedicated buses BS5 to the motion estimating circuit 8, image data can be simultaneously output. Further, in parallel to the motion estimation of full pixel precision and the motion estimation of half pixel precision, the image data of the reference macroblocks “5” and “12” which is used in motion estimation with respect to the next target macroblock “4” is transferred from the system memory 2 to the reference bank memory 4f of the reference image memory 4, this transfer is data transfer to the reference bank memory 4f which is not used for the motion estimation of full pixel precision and the motion estimation of half pixel precision, and therefore, is possible.

Next, in step 6, motion estimation of full pixel precision is performed with respect to the target macroblock “4” while referencing the image data of the reference macroblocks “3” to “5” and “10” to “12”, and while image data of the next target macroblock “5” is stored into the target block memory 3a of the target image memory 3, reference macroblocks “6” and “13” which are to be referenced in motion estimation with respect to this target macroblock are newly transferred from the system memory 2 and stored into the reference bank memory 4g of the reference image memory 4. At this time point, the image data of the six reference macroblocks “0” to “2” and “7” to “9” stored in the reference bank memories 4a to 4c of the reference image memory 4 are image data which are not used in motion estimation of full pixel precision with respect to the target macroblock “4”. Therefore, at the same time that motion estimation of full pixel precision is performed with respect to the target macroblock “4”, the image data of the target macroblock “1” in the target bank memory 3b of the target image memory 3 and the image data of the six reference macroblocks “0” to “2” and “7” to “9” stored in the reference bank memories 4a to 4c of the reference image memory 4 are output to the motion estimating circuit 8, and thereafter, motion estimation of half pixel precision is performed with respect to the target macroblock “1”.

Thereafter, in steps 7 to 10, as is similar to that described above, motion estimation of full pixel precision with respect to a target macroblock “k” (5≦k≦20) and motion estimation of half pixel precision with respect to a target macroblock “k-3” are simultaneously performed.

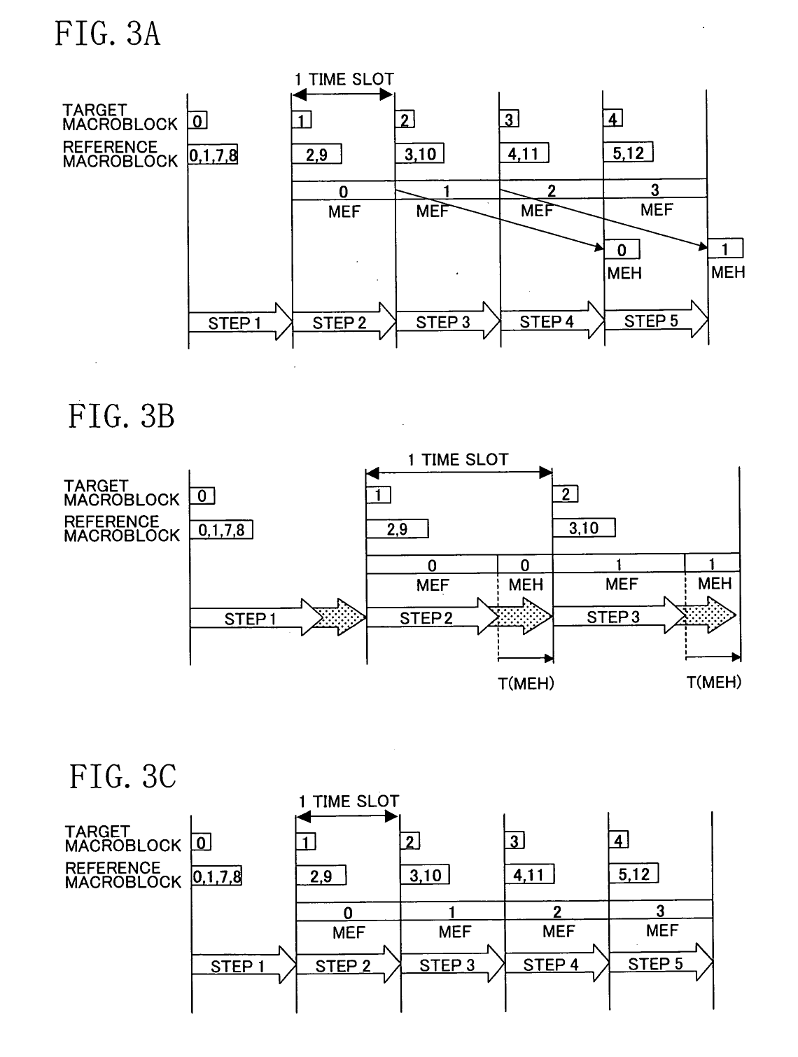

Therefore, in this example, when a search range for motion estimation is set to include a total of nine adjacent reference macroblocks around a reference macroblock having the same number as that of a target macroblock, while motion estimation of full pixel precision is performed with respect to the target macroblock, motion estimation of half pixel precision can be simultaneously performed with respect to a target macroblock three time slots before, as described in FIG. 3A (in FIG. 3A, while motion estimation is performed with respect to the target macroblock “3”, motion estimation of half pixel precision is performed with respect to the target macroblock “0”). Therefore, as illustrated in FIG. 3B, as compared to when motion estimation of full pixel precision and motion estimation of half pixel precision are successively performed in series with respect to the same target macroblock, a time of one time slot can be shortened, thereby making it possible to effectively increase the processing speed of high-precision motion estimation. Therefore, high-quality coding can be achieved even for HDTV moving images or the like.

Note that, in this example, as described above, the operation of the motion estimating circuit 8 controls motion estimation of full pixel precision, motion estimation of half pixel precision, and spare transfer of image data of a reference macroblock for motion estimation with respect to the next target macroblock in parallel. However, when there is a margin of the processing speed of motion estimation, the control may be switched to a control in which only motion estimation of full pixel precision is performed as illustrated in FIG. 3C, or a full/half pixel precision search serial execution control in which motion estimation of full pixel precision and motion estimation of half pixel precision are performed in series as illustrated in FIG. 3B, depending on the margin. The full/half pixel precision search serial execution control is specifically performed as follows. While image data of a plurality of reference macroblocks stored in a reference bank memory allocated to full pixel precision is transferred to the motion estimating circuit 8, image data of a plurality of reference macroblocks which are to be used for motion estimation with respect to the next target macroblock is transferred from the system memory 2 to a reference bank memory allocated to spare transfer. Thereafter, motion estimation of full pixel precision is performed. Thereafter, the image data of the reference macroblocks of the reference bank memory allocated to full pixel precision is transferred, as image data of a plurality of reference macroblocks for half pixel precision, to the motion estimating circuit 8.

Also, in this example, a search range for motion estimation with respect to a target macroblock is assumed to a range of (x, y)=3×3 reference macroblocks. However, the search range may be set to be any range, such as a range of 5×5 reference macroblocks, a range of 7×7 reference macroblocks, or the like.

### SECOND EXAMPLE

Next, a second example of the present invention will be described. This example relates to a motion estimating device in which a method of controlling motion estimation with respect to a target macroblock is not fixed and is changed as required.

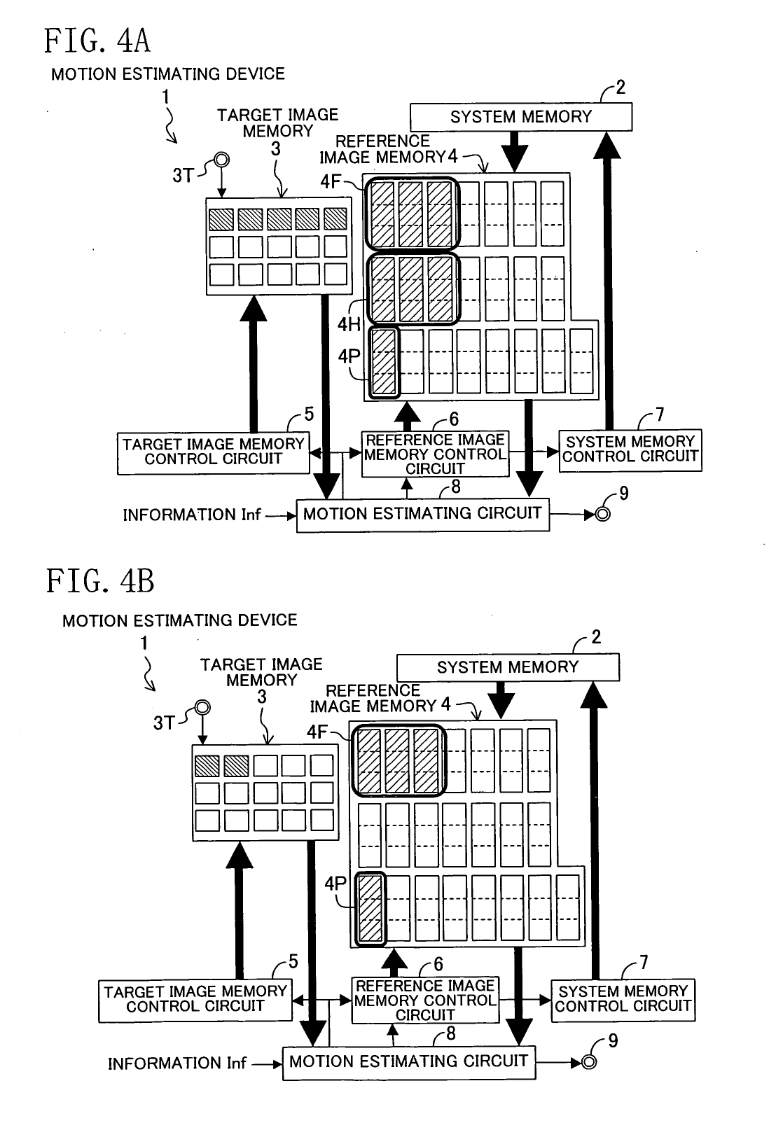

The motion estimating device of this example is illustrated in FIGS. 4A and 4B. The whole configuration of the motion estimating device of FIGS. 4A and 4B is similar to that of the motion estimating device of FIG. 1. Note that, in FIGS. 4A and 4B, the target image memory 3 and the reference image memory 4 have larger capacities than those of FIG. 1.

In a motion estimating device 1 illustrated in FIG. 4A, required performance information Inf about required performance of an image, such as image quality (a bit rate, etc.), a size, a frame rate or the like of the image, is input to a motion estimating circuit (bank configuration specifying section) 8. When the input required performance information Inf indicates that required image performance is high (e.g., when required image quality of an image is high image quality exceeding previously set standard image quality, when a size of an image is a large size exceeding a previously set standard size, or when a frame rate is a high frame rate exceeding a previously set standard frame rate, etc.), the amount of image data to be processed per unit time is large, and therefore, motion estimation should be performed with high speed. Therefore, in this case, the motion estimating circuit 8 performs motion estimation of full pixel precision, motion estimation of half pixel precision, and spare transfer of a reference memory block for motion estimation of the next target memory block in parallel (full/half pixel precision search parallel execution control method) as described in the first example. In other words, in this control method, as a bank configuration of the reference bank memory 4 is specified as illustrated in FIG. 4A so that three reference bank memories 4F are used for full pixel precision reference macroblocks, other three reference bank memories 4H are used for half pixel precision reference macroblocks, and another reference bank memory 4P are used for spare transfer.

On the other hand, when the required image performance is normal (e.g., when required image quality of an image is equal to standard image quality (normal image quality), when a size of an image is a standard size (normal size), when a frame rate is a standard frame rate (normal frame rate), etc.), motion estimation is performed at a normal rate. Therefore, in this case, the control method is changed to a conventional full/half pixel precision search serial execution control method in which, while motion estimation of full pixel precision is performed, spare transfer is performed for a reference memory block for motion estimation with respect to the next target memory block, and thereafter, motion estimation of half pixel precision is performed. In other words, in this case, a bank configuration in the reference image memory 4 is specified as illustrated in FIG. 4B so that any three reference bank memories 4F are used as reference macroblocks for full pixel precision and subsequent half pixel precision, and another reference bank memory 4P is used for spare transfer.

Therefore, in this example, a motion estimation control method can be changed, depending on required image performance of a system, such as image quality, a size, a frame rate or the like of an image, thereby making it possible to achieve image coding which flexibly supports a system requirement.

### THIRD EXAMPLE

Next, a motion estimating device according to a third example of the present invention will be described. Although a method of controlling motion estimation of a target macroblock is changed in the second example, a search range for motion estimation is changed in this example.

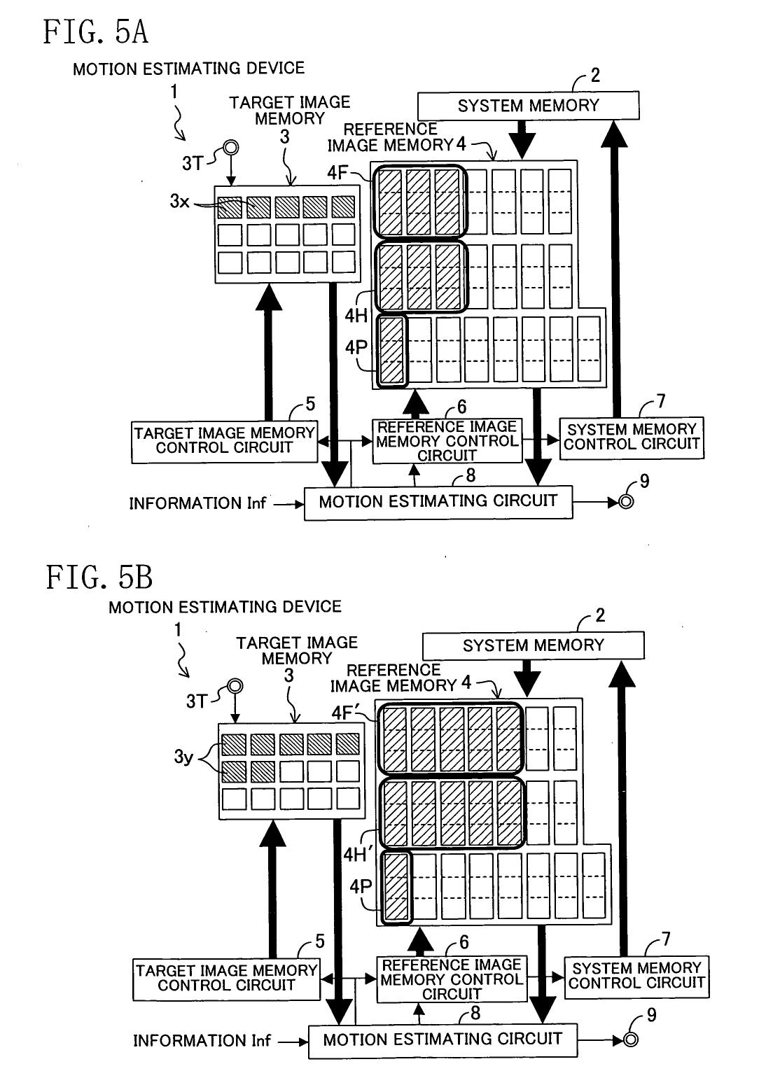

FIGS. 5A and 5B illustrate a whole configuration of a motion estimating device 1 according to this example. As in the first example, the motion estimating circuit 8 of FIGS. 5A and 5B performs a motion estimation control method in which motion estimation of full pixel precision, motion estimation of half pixel precision, and spare transfer for image data of a reference macroblock for motion estimation with respect to the next target macroblock are performed in parallel. As in the second example, the motion estimating circuit 8 receives required performance information Inf about required performance of an image, such as image quality, a size, a frame rate or the like of the image. Based on the required performance information Inf, the motion estimating circuit 8 determines whether or not required image performance of a system is high. When the required image performance is high, nine adjacent reference macroblocks around a reference macroblock having the same number as that of a target macroblock (the number of pixels in the horizontal direction is in the range −16 to +15.5) are set as ari initial search range corresponding to the required image performance. In this case, as illustrated in FIG. 5A, five target block memories 3x in the target image memory 3, and three reference bank memories 4F for full pixel precision, three reference bank memories 4H for half pixel precision, and one reference macroblock 4P for spare transfer in the reference image memory 4, which are hatched, are used.

On the other hand, when the required performance information Inf indicates that the required image performance is low, i.e., there is a margin of the processing speed of a motion estimation process, the motion estimating circuit 8 enlarges the initial search range including the nine adjacent reference macroblocks to an enlarged search range including, for example, three reference macroblocks above and below a reference macroblock having the same number as that of a target macroblock, and five reference macroblocks to the left and right of the reference macroblock (the number of pixels in the horizontal direction is in the range −32 to +31.5). Therefore, in this case, as illustrated in FIG. 5B, five reference bank memories 4F′ for full pixel precision, five reference bank memories 4H′ for half pixel precision, and one reference macroblock 4P for spare transfer are used in the reference image memory 4. In this case, seven target block memories 3y, which are hatched, are used in the target image memory 3.

Therefore, in this example, a search range for motion estimation is changed, depending on required image performance of a system. Therefore, when the required image performance is low, the search range is caused to be larger than when it is high, so that the number of pieces of image data used for motion estimation is increased. Thereby, a margin of motion estimation ability can be effectively used, resulting in an improvement in motion estimation precision.

### FOURTH EXAMPLE

Next, a motion estimating device according to a fourth example of the present invention will be described. In this example, the allocation of a reference macroblock to each reference bank memory in a reference image memory will be changed, depending on a coding method.

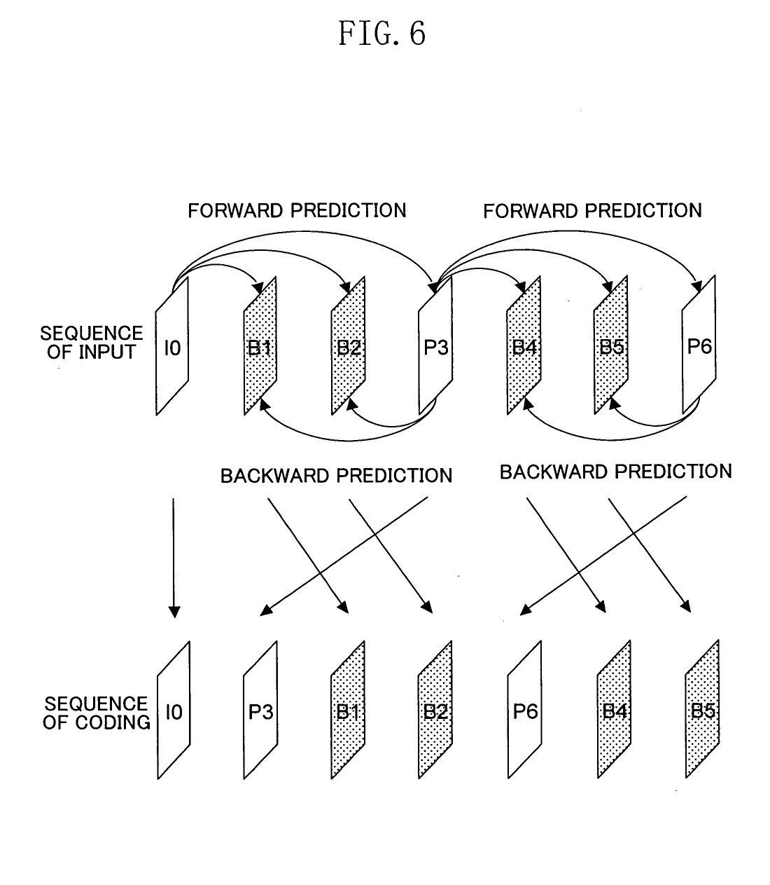

In MPEG, regarding motion-compensated prediction, not only forward prediction but also backward prediction are employed (bidirectional prediction), thereby improving coding efficiency. Bidirectional prediction is performed as follows. As illustrated in FIG. 6, initially, an I-picture I0 is intra-frame coded, and a P-picture P3 is coded with forward prediction. Thereafter, a B-picture B1 and a B-picture B2 are successively coded with bidirectional prediction using the I-picture I0 and the P-picture P3. In this example, the allocation of a reference macroblock in a reference image memory is changed, depending on a difference in coding method between such coding with bidirectional prediction and coding only with forward prediction.

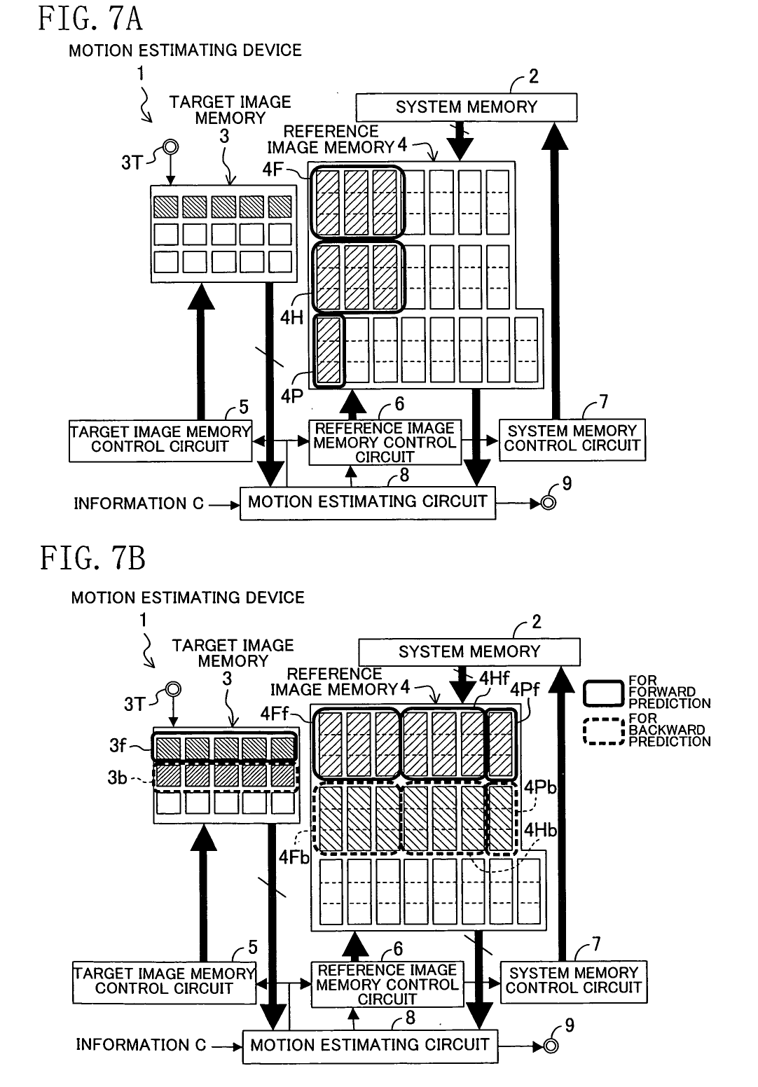

FIGS. 7A and 7B illustrate a whole configuration of the motion estimating device 1 of this example. The configuration of the motion estimating device 1 of FIGS. 7A and 7B is similar to that of the motion estimating device of FIG. 1. The motion estimating circuit 8 receives information C indicating whether a coding method employs bidirectional prediction or forward prediction. Based on the input information C about the coding method, when the coding method employs forward prediction using only I- and P-pictures, the motion estimating circuit 8 uses any three reference bank memories 4F for full pixel precision reference macroblocks, other three reference bank memories 4H for half pixel precision reference macroblocks, and another reference bank memory 4P for spare transfer, in the reference image memory 4, as illustrated in FIG. 7A.

On the other hand, when the information C about the coding method indicates bidirectional prediction, which employs I-, P- and B-pictures, the motion estimating circuit 8 allocates uppermost-row reference memories enclosed with a solid line of three rows of reference bank memories to forward prediction blocks, and uses three reference bank memories 4Ff for full pixel precision reference macroblocks, other three reference bank memories 4Hf for half pixel precision reference macroblocks, and another reference bank memory 4Pf for spare transfer. The motion estimating circuit 8 also allocates middle-row reference bank memories enclosed with a dashed line to backward prediction blocks, and uses three reference bank memories 4Fb for full pixel precision reference macroblocks, other three reference bank memories 4Hb for half pixel precision reference macroblocks, and another reference bank memory 4Pb for spare transfer, in the reference image memory 4, as illustrated in FIG. 7B. Also in the target image memory 3, similarly, five target block memories 3f on the uppermost row enclosed with a solid line are allocated to forward prediction blocks, and five target block memories 3b on the middle row enclosed with a dashed line are allocated to backward prediction blocks.

### FIFTH EXAMPLE

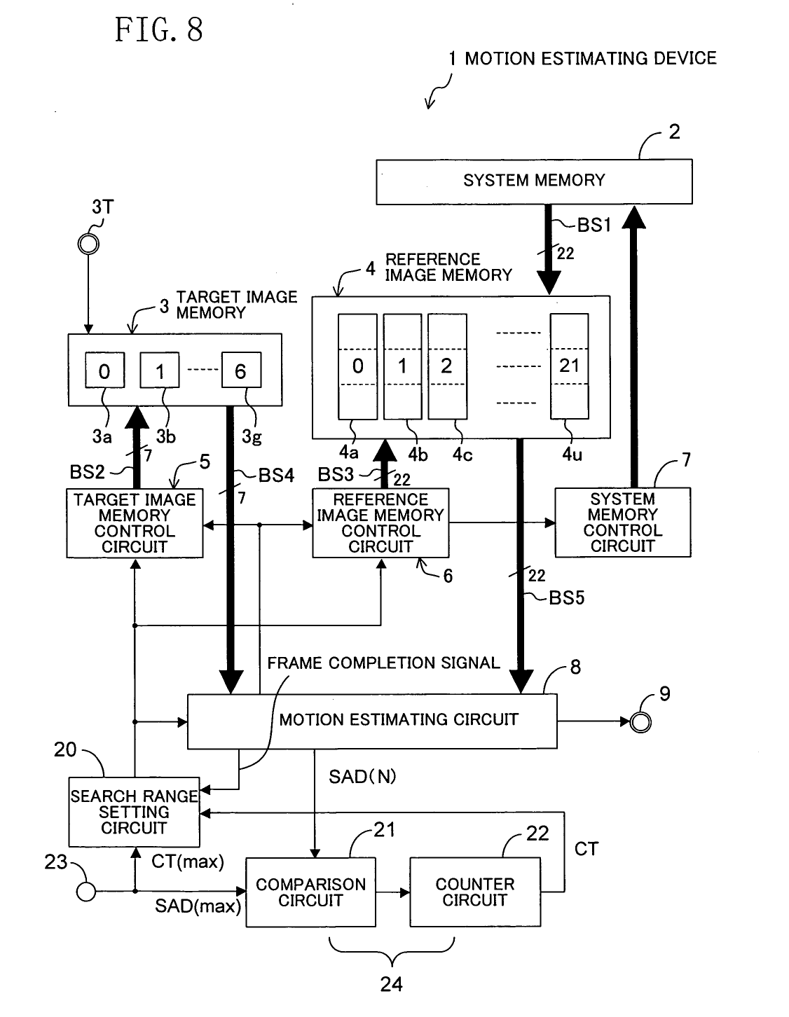

FIG. 8 illustrates a fifth example of the present invention. In this example, a search range for motion estimation is not fixed and is changed as required.

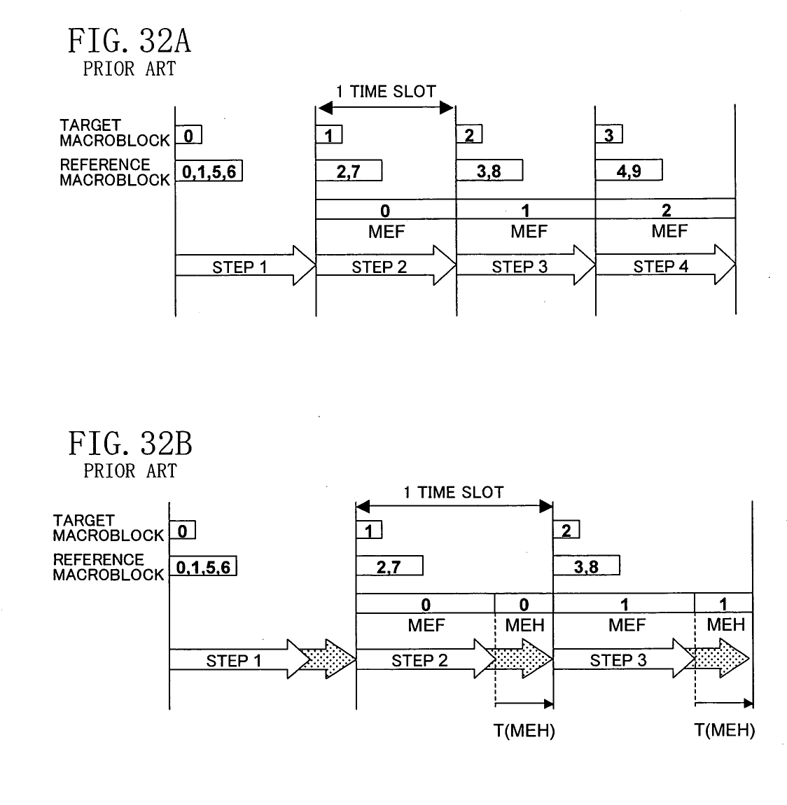

In a motion estimating device 1 of FIG. 8, a configuration of a system memory 2, a target image memory 3, a reference image memory 4, a target image memory control circuit 5, a reference image memory control circuit 6, a system memory control circuit 7, and a motion estimating circuit 8, is similar to that of FIG. 1. Therefore, the motion estimating device 1 of FIG. 8, motion estimation of full pixel precision, motion estimation of half pixel precision, and spare transfer for image data of a reference macroblock for motion estimation with respect to the next target macroblock, are performed in parallel. Although these three operations are performed in parallel in a control for motion estimation in this example, the present invention is not limited to this. For example, a control in which only motion estimation of full pixel precision is performed, or a control in which motion estimation of full pixel precision and motion estimation of half pixel precision are performed in series as illustrated in FIGS. 32A and 32B, may be performed.

In the motion estimating device 1 of FIG. 8, since a search range for motion estimation is set to be variable, the capacities of the target image memory 3 and the reference image memory 4 are set to be larger than those of FIG. 1. The target image memory 3 comprises seven target block memories 3a to 3g, and the reference image memory 4 comprises 22 reference bank memories 4a to 4u. The capacities of these are not particularly limited.

The motion estimating device 1 of FIG. 8 is different from that of FIG. 1 in that a search range setting circuit 20, a comparison circuit 21, and a counter circuit 22 are further provided in addition to the parts of FIG. 1. An operation for motion estimation in the motion estimating circuit 8 will be described in detail. In the motion estimation operation, a difference between values of corresponding pixels in a target macroblock and a reference macroblock is calculated for 256 pixels, and an accumulation value SAD of the absolute values of the differences in pixel value between these blocks is calculated. Further, these operations are repeatedly performed with respect to one frame including 64 macroblocks to obtain accumulation values SAD(N) (N=1 to 64) of the absolute values of the differences in pixel value which are eventually obtained for the respective separate macroblocks.

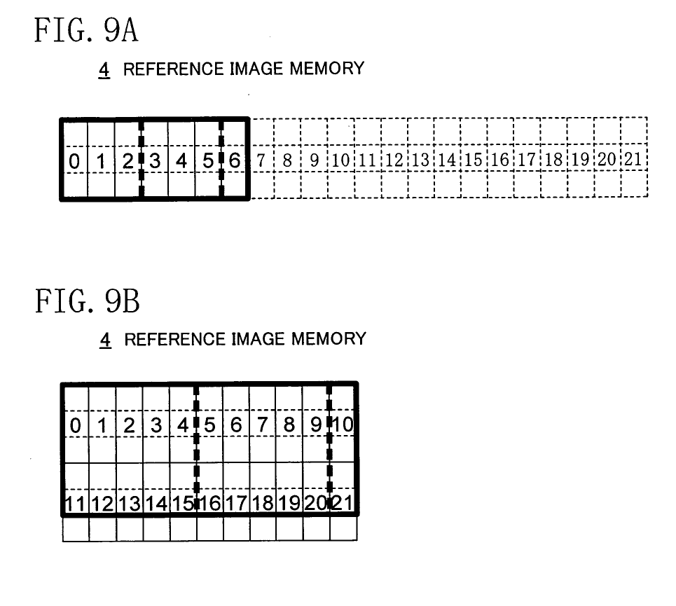

The comparison circuit 21 receives a threshold value SAD(max) of the accumulation values SAD of the absolute values of the differences in pixel value from an external terminal 23, compares the accumulation value SAD(N) of the absolute values of the differences in pixel value from the motion estimating circuit 8 with the threshold value SAD(max) from the external terminal 23, and outputs the result of the comparison to the counter circuit 22. Based on the comparison result from the comparison circuit 21, the counter circuit 22 adds one to a count value only when SAD(max)<SAD(N), and outputs the count value CT to the search range setting circuit 20. The search range setting circuit 20 receives from the external terminal 23 a maximum value CT(max) which is previously set for count values of the counter circuit 22, and when the motion estimating circuit 8 completes motion estimation with respect to 64 macroblocks in one frame, receives a frame completion signal from the motion estimating circuit 8, and when receiving the completion signal, compares the maximum value CT(max) from the external terminal 23 with the count value CT from the counter circuit 22, and when CT(max)<CT, determines that there is a significant motion (i.e., prediction precision is low), and enlarges a search range from a normal range of (x, y)=3×3 macroblocks to a range of 5×5 macroblocks, and changes the bank configuration of the reference image memory 4 from a normal range of seven reference macroblocks (FIG. 9A) to an enlarged range of a total 22 macroblocks (FIG. 9B). In FIG. 9B, an enlarged bank configuration is illustrated in which 11 macroblocks are arranged in the horizontal direction (a first direction in which a target macroblock image is processed), and five macroblocks are arranged in the vertical direction (a second direction perpendicular to the first direction). Therefore, when a motion is normal, a search range is a range of (x, y)=3×3 reference macroblocks, and when a motion is significant (i.e., prediction precision is low), a search range is enlarged to a range of (x, y)=5×5 reference macroblocks. The comparison circuit 21 and the counter circuit 22 constitute a prediction precision detecting section 24 which detects the prediction precision of motion estimation in an image set range of (x, y)=3×3 reference macroblocks.

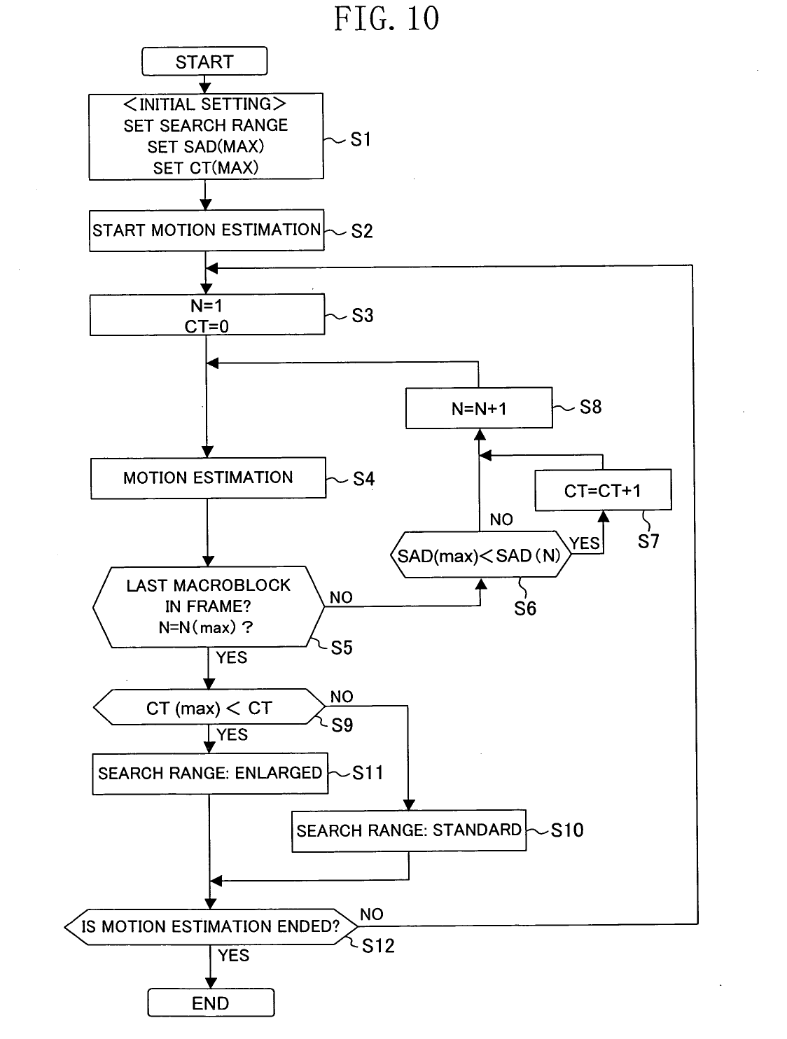

Next, a motion estimation operation of this example will be described based on a control flowchart of FIG. 10.

After start, in step S1, a search range for motion estimation is set to be a normal range of (x, y)=3×3 macroblocks, and the bank configuration of the reference image memory 4 is set to be the normal range of FIG. 9A. In addition, the threshold value SAD(max) of the accumulation values SAD of the absolute values of the differences in pixel value for one macroblock is input from the external terminal 23 to the comparison circuit 21, and the maximum value CT(max) of the count values is input to the search range setting circuit 20 (initial setting). Thereafter, in step S2, the motion estimating circuit 8 is activated to start the motion estimation operation. In step S3, the number N of macroblocks for which motion estimation has been finished is initially set to be N=1, and the count value CT of the counter circuit 22 is initially set to be CT=0.

Thereafter, in step S4, motion estimation is performed with respect to a first target macroblock, the accumulation value SAD(N=1) of the absolute values of the differences in pixel value for one macroblock is calculated. In step S5, it is determined whether or not a target macroblock for which the accumulation value SAD of the absolute values of the differences in pixel value is currently calculated, is the last macroblock of one frame. Since the result of the determination is initially NO, the currently obtained accumulation value SAD(N) of the absolute values of the differences in pixel value is compared with the threshold value SAD(max) in step S6. When SAD(N) exceeds the threshold value (SAD(max)<SAD(N)), 1 is added to the count value CT (CT=CT+1) in step S7 and the operation goes to step S8. When SAD(N) is smaller than or equal to the threshold value (SAD(max)≧SAD(N)), the operation immediately goes to step S8, 1 is added to the number N of target macroblocks which have been subjected to motion estimation (N=N+1), and the operation returns to step S4. Thereafter, in step S5, the above-described operation is repeatedly performed until a target macroblock which is currently subjected to motion estimation is the last macroblock of one frame, and when the current target macroblock is eventually the last macroblock of one frame, the operation goes to step S9.

In step S9, since motion estimation has been finished with respect to one frame, the count value CT of the counter circuit 22 is compared with the maximum value CT(max) (set value). When CT(max)≧CT, it is determined that the prediction precision is high. In this case, in step S10, a search range is set to be the normal range of (x, y)=3×3 macroblocks, the bank configuration of the reference image memory 4 is set to be the normal range of FIG. 9A. When the prediction precision is low (CT(max)<CT), a search range is set to be the enlarged range of (x, y)=5×5 macroblocks, and the bank configuration of the reference image memory 4 is set to be the enlarge range of FIG. 9B in step S11. Thereafter, in step S12, it is determined whether or not the motion estimation operation is finished. When it is not finished and the operation goes to motion estimation with respect to the next frame, the operation returns to step S3. When the motion estimation operation is finished, the motion estimation operation is immediately finished.

Therefore, in this example, as the result of motion estimation with respect to one frame, when a motion is significant and the prediction precision is determined to be low, a search range for motion estimation is caused to be larger than the normal range, so that the prediction precision of motion estimation can be improved. On the other hand, when the prediction precision is determined to be high, a search range for motion estimation is maintained to be the normal range. Therefore, as compared to when the search range is set to be the enlarged range, it is possible to suppress an increase in power consumption when a large number of pieces of image data in the enlarged range are subjected to motion estimation while keeping high prediction precision.

### SIXTH EXAMPLE

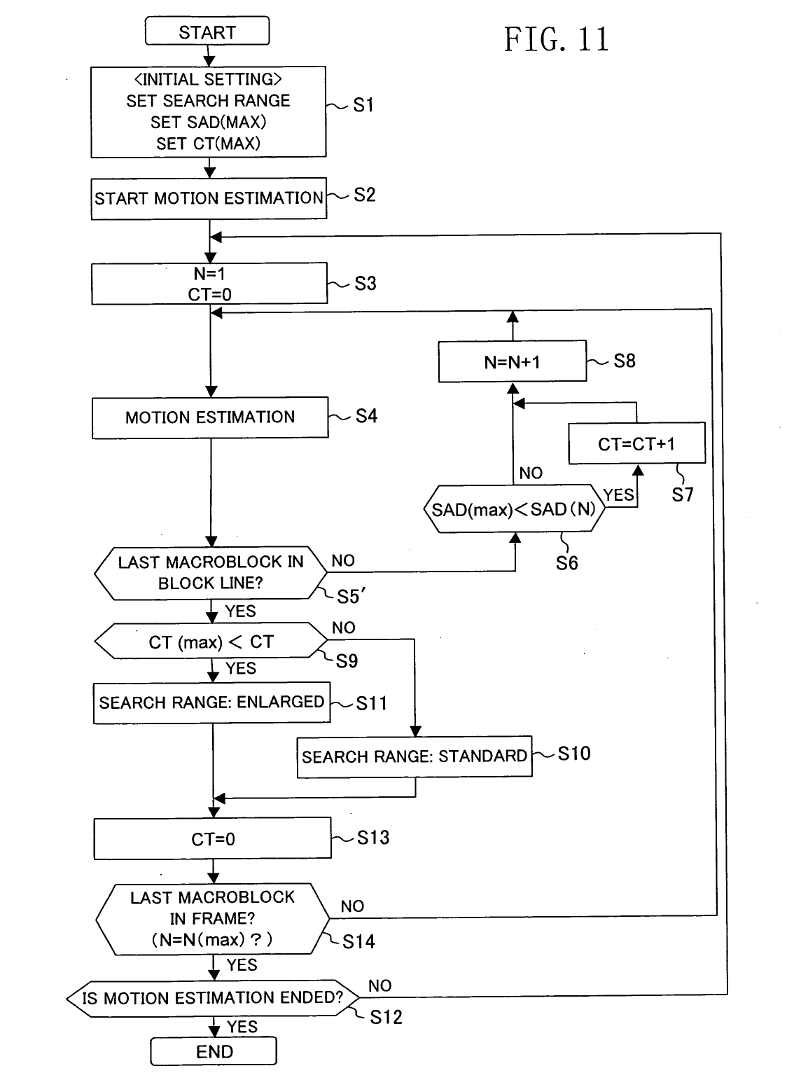

FIG. 11 illustrates a sixth example of the present invention. Although motion estimation is performed with respect to one frame to determine whether the prediction precision is high or low in the fifth example, motion estimation is performed with respect to a block line immediately above a block line in the horizontal direction which includes a target macroblock which is currently subjected to motion estimation, to determine whether the prediction precision is high or low in this example. The whole configuration of a motion estimating device of this example is the same as that of FIG. 8 and will not be described.

A control flowchart of motion estimation of FIG. 11 is different from the control flowchart of FIG. 10 in that step S5 is changed to step S5′, and steps S13 and S14 are added. In the control flowchart of FIG. 11, after motion estimation is performed in step S4, it is determined whether or not a target macroblock which is currently subjected to motion estimation is the last macroblock on a block line to which the target macroblock belongs, in step S5′. When the target macroblock is the last macroblock, the count value CT of the counter circuit 22 on the block line is immediately compared with the maximum value CT(max) in step S9. If CT(max)<CT, a search range is enlarged in step S11. If CT(max)≧CT, a search range is set to be an initial standard range in step S10. Further, after the search range is changed based on prediction precision on the current block line, the count value CT is returned to the initial value (CT=0) so that motion estimation is performed with respect to the next block line in step S13. Thereafter, in step S14, it is determined whether or not the target macroblock is the last macroblock in one frame, i.e., whether or not the number N of macroblocks which have been subjected to motion estimation is the maximum number N(max) (=64). If N≠N(max), the operation returns to step S4 and the next block line is subjected to motion estimation.

Therefore, in this example, a search range is changed based on the prediction precision of motion estimation with respect to an immediately previous block line. Therefore, as compared to the fifth example in which a search range is changed based on the prediction precision in an immediately previous frame, the frequency of changing of a search range is increased, thereby making it possible to further improve coding efficiency even when a significant motion is present in an image.

### SEVENTH EXAMPLE

Next, a seventh example of the present invention will be described. Although a search range is changed based on the prediction precision of motion estimation in an immediately previous frame in the fifth example, motion position information between an optimal prediction reference macroblock having a smallest total value of the absolute values of the difference values between corresponding pixels, and a target macroblock, is obtained as a motion vector (motion-compensated prediction), and based on the magnitude of the motion vector, a search range is changed in this example.

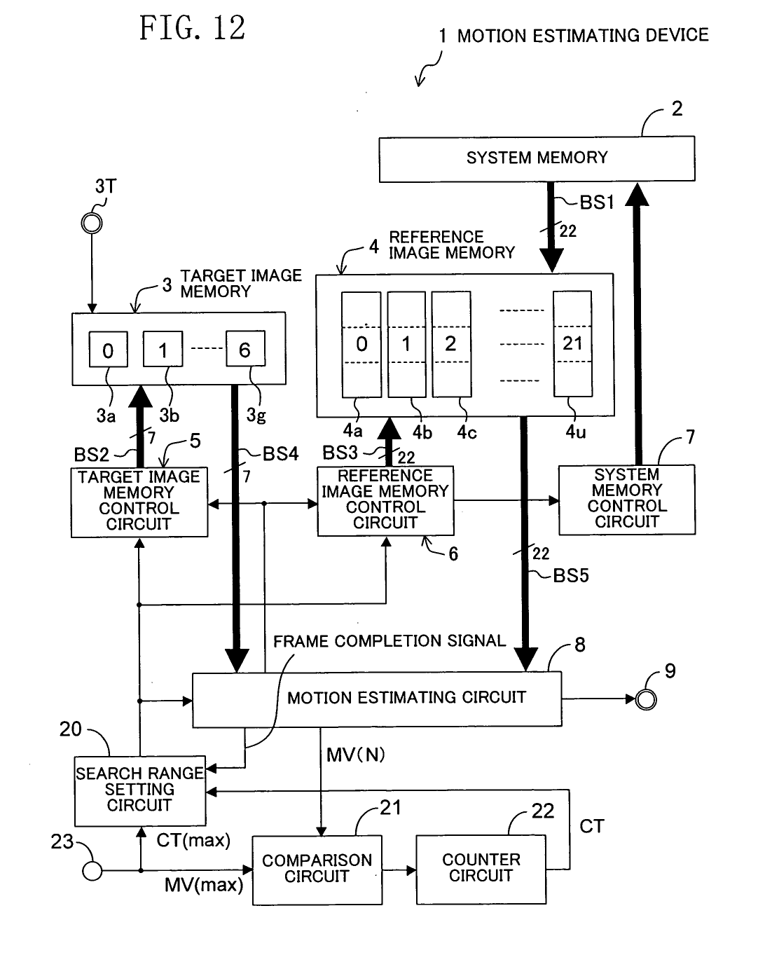

FIG. 12 illustrates a whole configuration of a motion estimating device 1 of this example. The whole configuration of the motion estimating device 1 is similar to that of the fifth example of FIG. 8. In the motion estimating device 1 of FIG. 12, the motion estimating circuit 8 calculates a motion vector MV having a direction and a distance extending from an optimal prediction reference macroblock to a target macroblock as motion position information between the target macroblock and the optimal prediction reference macroblock in a previously set image range of (x, y)=3×3 reference macroblocks. The motion vector MV is repeatedly calculated for N(N=64) separate target macroblocks, and the motion vector MV(N) for each separate target macroblock is output to the comparison circuit 21. The comparison circuit 21 also receives a previously set maximum value MV(max) (reference value) of the motion vector MV from the external terminal 23. The comparison circuit (comparison section) 21 compares the motion vector MV of each target macroblock with the set maximum value MV(max).

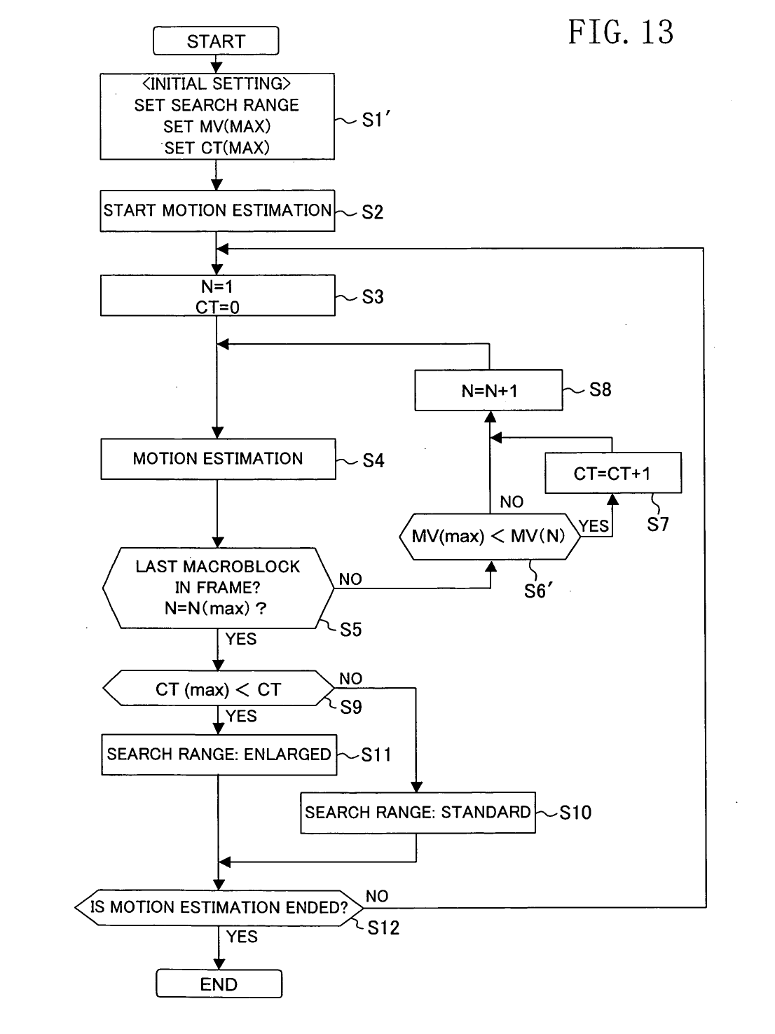

FIG. 13 is a control flowchart of motion estimation of the motion estimating device 1 of FIG. 12. The control flowchart of FIG. 12 is substantially similar to the control flowchart of FIG. 10, except that the set maximum value MV(max) of the motion vector is input from the external terminal 23 to the comparison circuit 21 in step S1′, and every time a motion vector MV(N) is obtained for a target macroblock N (N=1 to 64), the motion vector MV(N) is compared with the set maximum value MV(max) in step S6′, and when MV(max)<MV(N), 1 is added to the count value CT (CT=CT+1) in the counter circuit 22 in step S7.

Therefore, also in this example, a search range for motion estimation is changed based on the magnitude of a motion vector. Therefore, as in the fifth example, when a motion is significant in an image (i.e., the prediction precision is low), a search range for motion estimation is enlarged, thereby making it possible to improve the prediction precision of motion estimation. Also, when the prediction precision is high, a search range for motion estimation is maintained to be the normal range, thereby making it possible to reduce an increase in power consumption.

### EIGHTH EXAMPLE

Next, an eighth example of the present invention will be described.

Although motion estimation is performed with respect to one frame to determine the prediction precision in the seventh example, the prediction precision is determined for each block line in the horizontal direction in this example as in the sixth example.

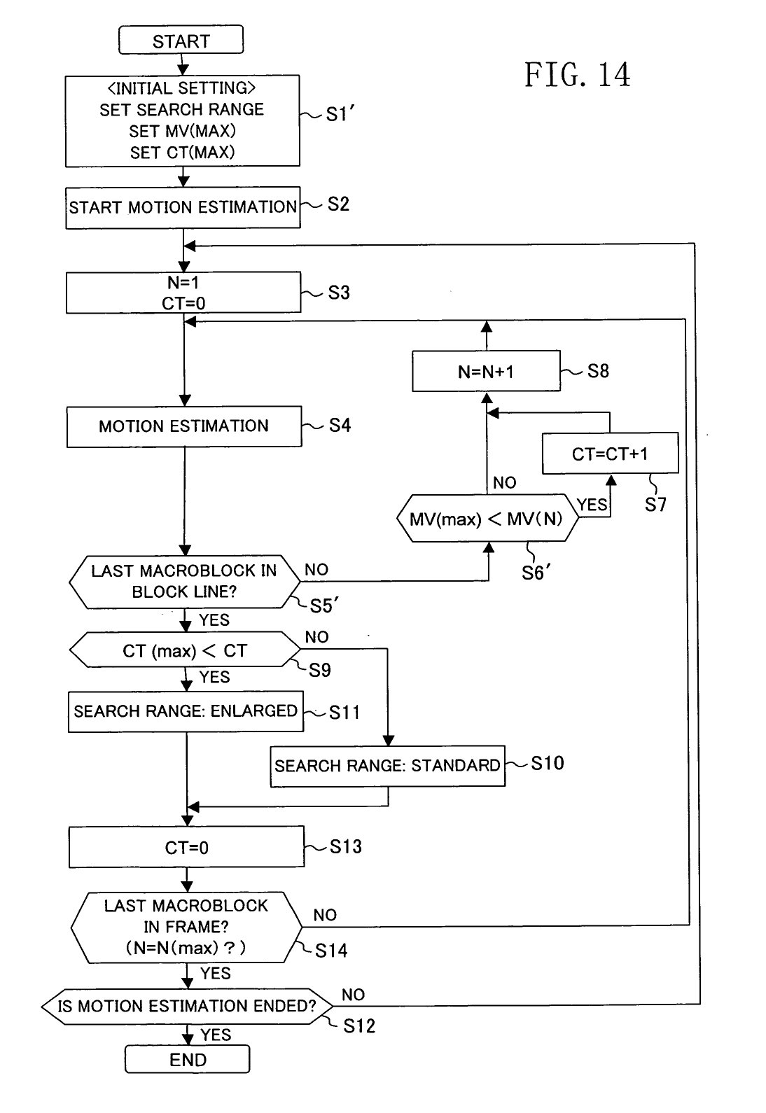

A control flowchart of motion estimation of this example of FIG. 14 is similar to the control flowchart of the sixth example of FIG. 11, only except that, although the total value SAD(N) of the absolute values of the corresponding difference values is calculated in the control flowchart of FIG. 11, the motion vector MV(N) is calculated in the control flowchart of FIG. 14, and will not be described in detail.

### NINTH EXAMPLE

Next, a ninth example of the present invention will be described. Although, when a motion vector MV exceeds the set maximum value MV(max), a search range is enlarged so that the number of reference bank memories used in the reference image memory 4 is increased in the eighth example, it is determined whether the horizontal component (distance) or the vertical component (distance) of the calculated motion vector MV is larger than the other, and a search range is enlarged in a direction corresponding to the larger component in this example.

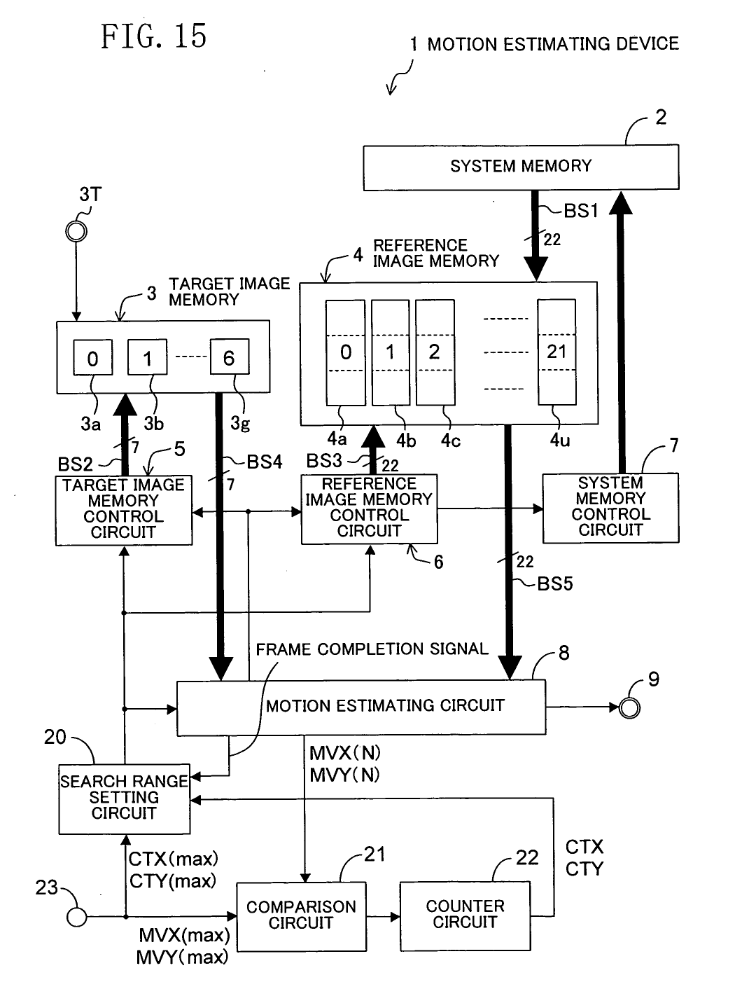

FIG. 15 is a whole configuration of a motion estimating device 1 of this example. The configuration of the motion estimating device 1 of FIG. 15 is similar to that of FIG. 12, only except for the following point. Specifically, the motion estimating circuit 8 separates and outputs a horizontal direction distance MVX(N) and a vertical direction distance MVY(N) of the calculated motion vector MV(N) to the comparison circuit 21. The comparison circuit 21 also receives, from the external terminal 23, a maximum value MVX(max) (a horizontal direction reference value) of the horizontal direction distance of the motion vector and a maximum value MVY(max) (a vertical direction reference value) of the vertical direction distance of the motion vector. The comparison circuit 21 compares the horizontal direction distance MVX(N) of the input motion vector with the maximum value MVX(max) of the horizontal direction distance. When MVX(max)<MVX(N), 1 is added to a count value CTX of the horizontal direction, and the vertical direction distance MVY(N) of the input motion vector is compared with the maximum value MVY(max) of the vertical direction distance. When MVY(max)<MVX(N), 1 is added to a count value CTY of the vertical direction, and the count values CTX and CTY are output to the search range setting circuit 20. The search range setting circuit 20 also receives, from the external terminal 23, maximum values CTX(max) and CTY(max) of the count values CTX and CTY of the horizontal direction and the vertical direction, respectively, and compares these maximum values CTX(max) and CTY(max) with the count values CTX and CTY of the horizontal direction and the vertical direction from the counter circuit 22, respectively. Thereafter, the search range setting circuit 20 controls the reference image memory control circuit 6 to increase the number of reference bank memories used in the reference image memory 4 (i.e., when CTX(max)<CTX, a search range is enlarged in the horizontal direction, and when CTY(max)<CTY, a search range is enlarged in the vertical direction), and correspondingly, increase the number of target block memories 3a to 3g used in the target image memory 3.

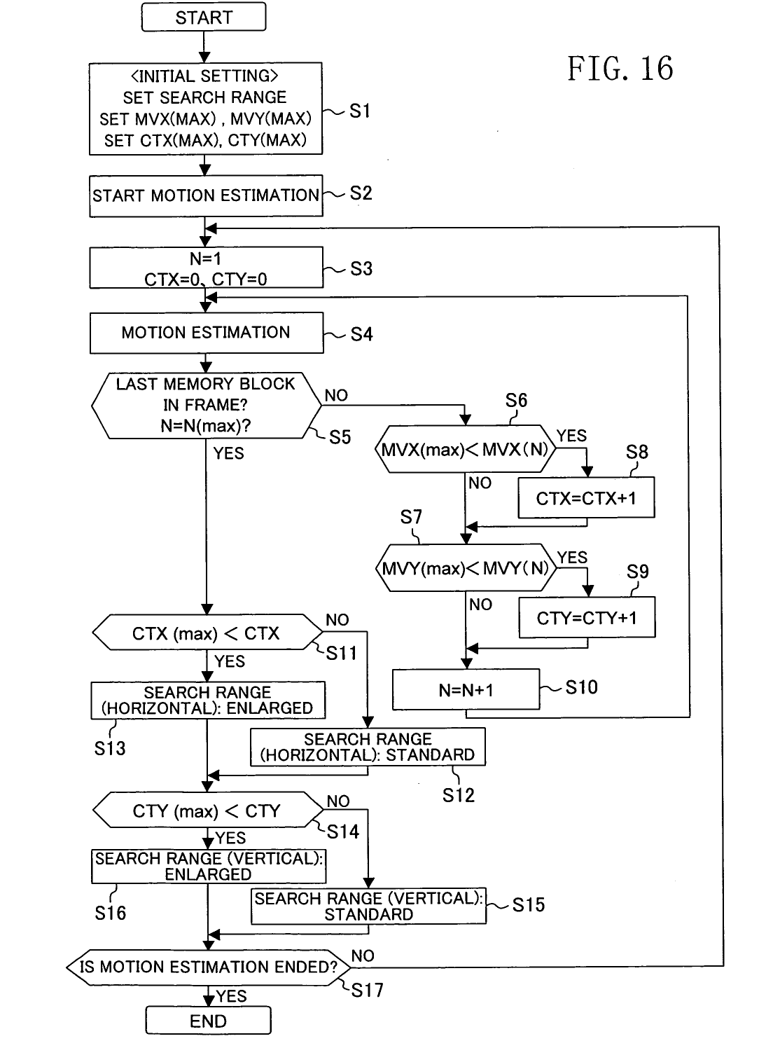

Next, a control for motion estimation in this example will be described with reference to a control flowchart of FIG. 16.

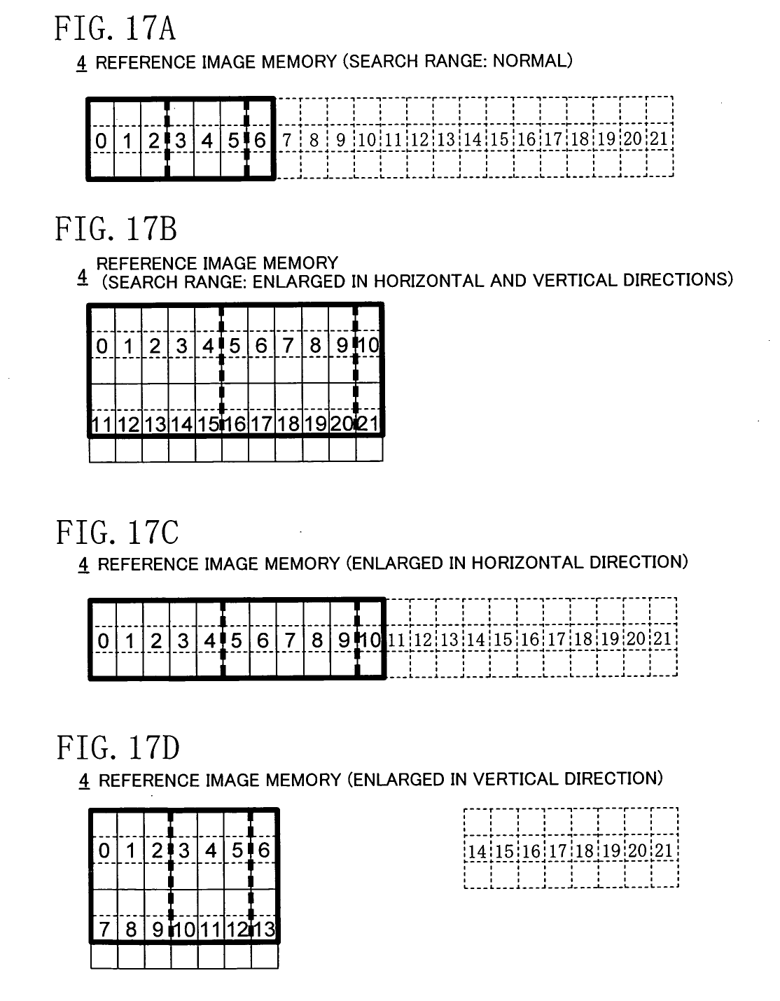

In the control flowchart of FIG. 16, after start, in step S1, a search range for motion estimation is set to be a normal range of (x, y)=3×3 macroblocks, and the bank configuration of the reference image memory 4 is initially set to be the normal range as illustrated in FIG. 17A. This normal range is a range in which seven reference macroblocks are used in the horizontal direction in FIG. 17A. Also, in the initial setting in step S1, the maximum value MVX(max) in the horizontal direction (X direction) and the maximum value MVY(max) in the vertical direction (Y direction) of the motion vector MV are input from the external terminal 23 to the comparison circuit 21 (initial setting), and the maximum value CTX(max) in the X direction and the maximum value CTY(max) in the Y direction of the count value CT of the counter circuit 22 are input from the external terminal 23 to the search range setting circuit 20 (initial setting).

Thereafter, in step S2, the motion estimating circuit 8 is activated to start a motion estimation operation. In step S3, the number N of macroblocks which have been subjected to motion estimation is initially set to be N=1, and the count values CTX and CTY of the X direction and the Y direction in the counter circuit 22 are initially set to be CTX=0 and CTY=0, respectively.

Thereafter, in step S4, motion estimation is performed with respect to a first target macroblock (N=1) to calculate a motion vector MV(N=1). The motion vector MV is represented by a combination value of a horizontal direction distance MVX(N) and a vertical direction distance MVY(N). Next, in step S5, it is determined whether or not a target macroblock N which is currently subjected to motion estimation is the last macroblock in a frame to which the target macroblock N belongs. When the target macroblock N is not the last macroblock, the horizontal direction distance MVX(N) and the vertical direction distance MVY(N) of the motion vector MV are compared with the set maximum values MVX(max) and MVY(max) in steps S6 and S7. When MVX(max)<MVX(N), 1 is added to the count value CTX of the horizontal direction in step S8. When MVY(max)<MVY(N), 1 is added to the count value CTY of the vertical direction in step S9. Thereafter, 1 is added to the number N of macroblocks which have been subjected to motion estimation in step S10. Thereafter, the operation returns to step S4, and motion estimation is repeated with respect to the next target macroblock.

Finally, when motion estimation is finished with respect to all target macroblocks in one frame, the operation goes from step S5 to step S11, in which the precision of motion compensation is determined as follows. Initially, the count value CTX of the horizontal direction is compared with the set maximum value CTX(max). If CTX(max)≧CTX, the precision of motion compensation is determined to be satisfactory, and a search range in the horizontal direction is set to be a standard range in step S12. On the other hand, if CTX(max)<CTX, the precision of motion compensation in the horizontal direction is determined to be low, and a search range in the horizontal direction is set to be an enlarged range in step S13. The enlarged range is a range of, for example, (x, y)=5×3 macroblocks, and as illustrated in FIG. 17C, the bank configuration of the reference image memory 4 is set to have eleven reference macroblocks in the horizontal direction. Also, in step S14, the count value CTY of the vertical direction is compared with the set maximum value CTY(max). If CTY(max)≧CTY, the precision of motion compensation in the vertical direction is determined to be satisfactory, and a search range in the vertical direction is set to be a standard range in step S15. If CTY(max)<CTY, the precision of motion compensation in the vertical direction is determined to be low, and a search range in the vertical direction is set to be an enlarged range in step S16. The enlarged range is a range of, for example, (x, y)=3×5 macroblocks, and as illustrated in FIG. 17D, two reference bank memories are used in the vertical direction, so that the enlarged range is composed of five reference macroblocks in the vertical direction. As the result of comparison of the count values in steps S11 and S14, when a search range is enlarged both in the X direction and in the Y direction, the search range is a range of, for example, (x, y)=5×5 macroblocks, and as illustrated in FIG. 17B, the bank configuration of the reference image memory 4 has a range in which eleven reference macroblocks are used in the X direction and five reference macroblocks are used in the Y direction.

Thereafter, in step S17, it is determined whether or not the motion estimation operation is ended. When the motion estimation operation is not ended and motion estimation is performed with respect to the next frame, the operation returns to step S3. When the motion estimation operation is ended, the motion estimation operation is immediately ended.

Therefore, in this example, prediction precision is determined in the X direction and the Y direction of a search range separately. The search range for motion estimation is enlarged only in a direction in which the prediction precision is low. Therefore, the search range is limited to a small range in which high prediction precision can be secured. Therefore, prediction precision can be improved without increasing an image data amount used for motion estimation more than necessary or increasing a data processing time.

### TENTH EXAMPLE

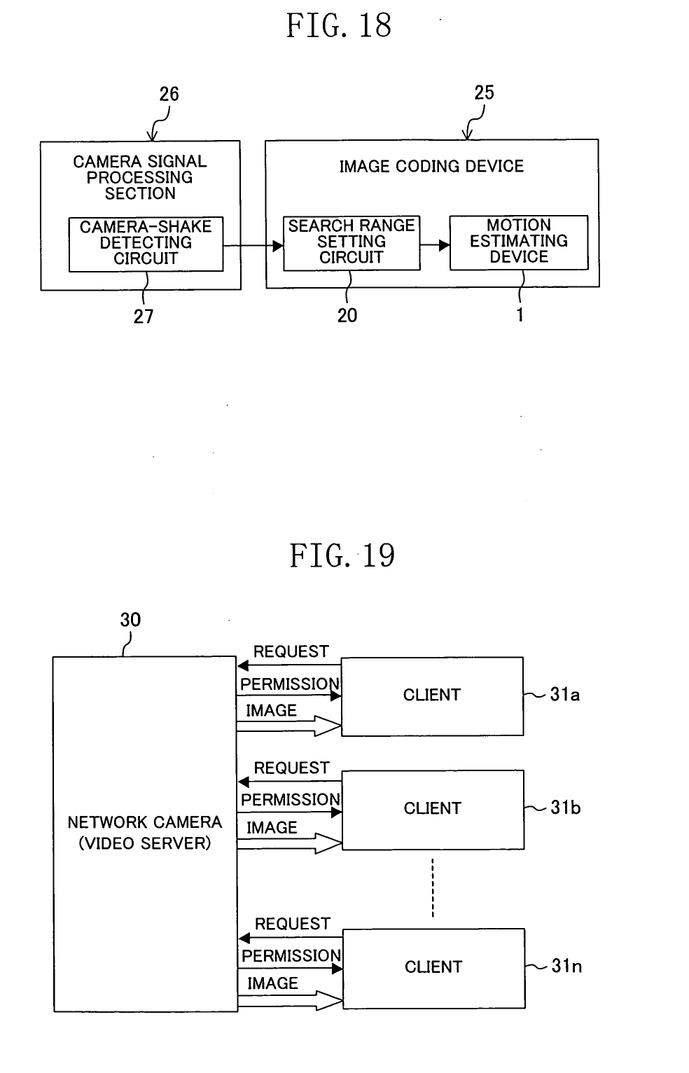

FIG. 18 illustrates a tenth example of the present invention. In the fifth to ninth examples, the comparison circuit 21 and the counter circuit 22 are provided so that the total value of the absolute values of the difference values or the motion vector of image data detected by the motion estimating circuit 8 is compared with a set value, and depending on the result of the comparison, the prediction precision of motion compensation is determined, and depending on whether the prediction precision is high or low, a search range is variably changed. In this example, the comparison circuit 21 and the counter circuit 22 are not provided, and information about the prediction precision of motion compensation is obtained from another device so as to variably set a search range.

Specifically, in FIG. 18, 25 indicates an image coding device for entropy-coding an input image signal, comprising the motion estimating device 1 of FIG. 1 and the search range setting circuit 20 of FIG. 8. 26 indicates a camera signal processing section which is incorporated in a digital camera or a camcorder (image capturing section; not shown), comprising a camera-shake detecting circuit 27. The camera-shake detecting circuit (change detecting section) 27 is a circuit which detects a motion (position change) between consecutive frames in video of a subject due to camera-shake of the main body of a camera when an operator operates the camera main body to capture the video of the subject. As is similar to the motion vector MV described in the seventh example, information indicating a position change between two consecutive frames in the video of the subject is obtained. For example, in an electronic camera-shake correcting circuit which performs comparison computation with respect to image data between image frames to correct camera-shake, the camera-shake detecting circuit 27 may be a circuit for performing the comparison computation. In an optical camera-shake correcting circuit which corrects a deviation of an optical axis due to camera-shake using a lens, the camera-shake detecting circuit 27 may be a circuit which detects a tilt of a camera using a gyro-sensor.

The search range setting circuit 20 of the image coding circuit 25 receives position change information from the camera-shake detecting circuit 27 of the camera signal processing section 26, and based on the position change information, enlarges a search range for motion estimation when a position change between two frames is large, and sets a search range to be a normal range when a position change is small.

Therefore, in this example, only the search range setting circuit 20 is added to a motion estimating device, and information based on which a search range is variably set is externally input, thereby making it possible to reduce a size of the motion estimating device.

### ELEVENTH EXAMPLE

Next, an eleventh example will be described. This example is applied to a network camera.

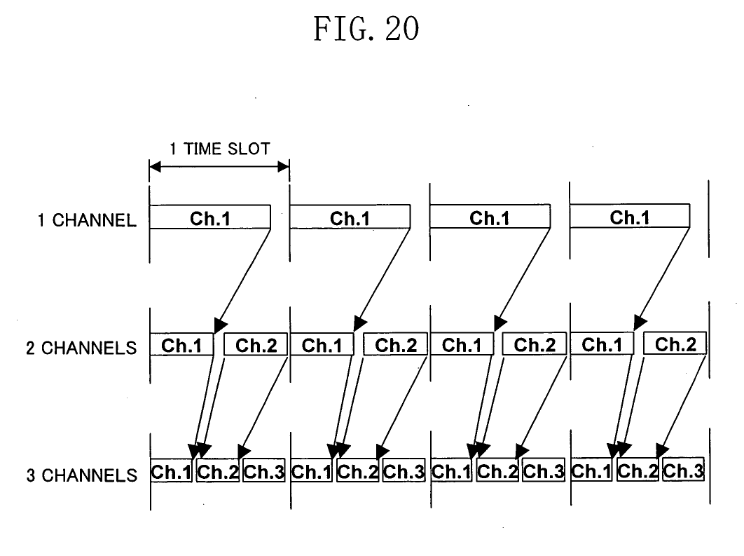

The network camera is, for example, a surveillance camera which captures video of one or a plurality of places which can be monitored in real time by a personal computer, a mobile telephone or the like via the Internet, a LAN, or the like. Regarding such a network camera, as illustrated in FIG. 19, a network camera 30 having one or a plurality of image capturing sections (not shown) is provided as a video server, and a plurality of clients (image terminals) 31a, 31b, . . . , and 31n which are connected to the network camera 30 via the Internet or the like are provided. When any of the clients outputs a signal requesting an image to the network camera 30, the network camera 30 outputs a permission signal corresponding to the request signal, and transmits a predetermined image signal to the client which has transmitted the request. It is here assumed that the number of clients which output an image request signal is one (one channel). In this case, as illustrated in FIG. 20, the entire time of one time slot can be used for coding of an image signal and transmission of the coded data to the requesting client. However, when the number of clients which output a request signal increases (two channels, three channels, etc.), a coding process needs to be completed during a gradually reduced time, such as half of one time slot, ⅓ of one time slot, or the like, and therefore, the speed of the process of coding an image signal needs to be increased. Further, the coding method or the search range needs to be changed, depending on an image size or an image frame rate, so as to support different types of video devices possessed by clients, such as a camera of a mobile telephone, a personal computer, or the like. A motion estimating device of this example is used in such a case.

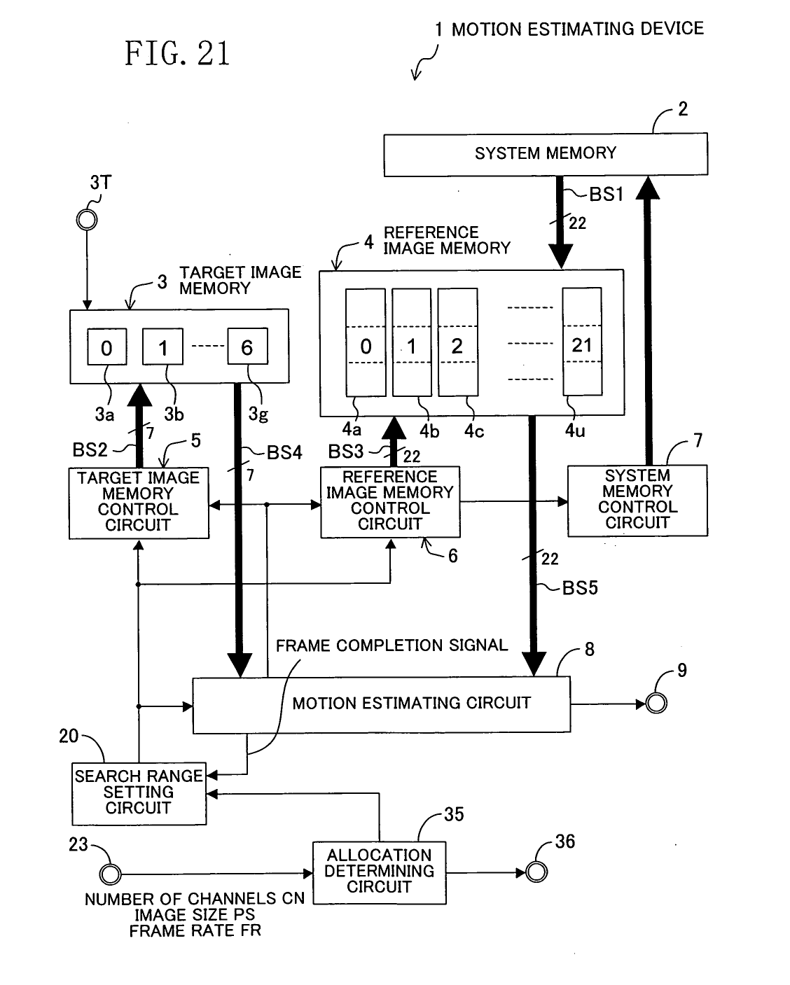

FIG. 21 illustrates a configuration of the motion estimating device of this example. The whole configuration of the motion estimating device of FIG. 21 is similar to that of the motion estimating device of FIG. 1, except that a search range setting circuit 20 and an allocation determining circuit 35 are provided.

The allocation determining circuit 35 receives, from the external terminal 23, information about the number of clients which simultaneously output image request signals to the network camera 30 (i.e., the number of channels CN), and an image size PS and a frame rate FR of a video device of each client. Based on the information about these, the allocation determining circuit 35 also outputs a permission signal from an output terminal 36 to all or a part of the clients which have output the request signals, and depending on the number of the permitted clients, outputs a control signal including the number of channels CN, the image size PS, and the frame rate FR to the search range setting circuit 20 so as to set a search range for motion estimation.

Based on the number of channels CN included in the control signal received from the allocation determining circuit 35, the search range setting circuit 20 sets a search range. Specifically, when the number of channels CN=3, the search range is set to be a normal range including nine reference macroblocks around a reference macroblock having the same number as that of a target macroblock (−16 to +15.5 pixels in the X and Y directions). When the number of channels CN=2, the search range is enlarged in the X direction and is set to be a range of a total 15 reference macroblocks having five macroblocks in the X direction and three macroblocks in the Y direction around a reference macroblock having the same number as that of a target macroblock (−32 to +31.5 pixels in the X direction and −16 to +15.5 pixels in the Y direction). When the number of channels CN=1, the search range is enlarged in both the X and Y directions, and is set to be a range 25 macroblocks around a reference macroblock having the same number as that of a target macroblock (−32 to +31.5 pixel in the X and Y directions).

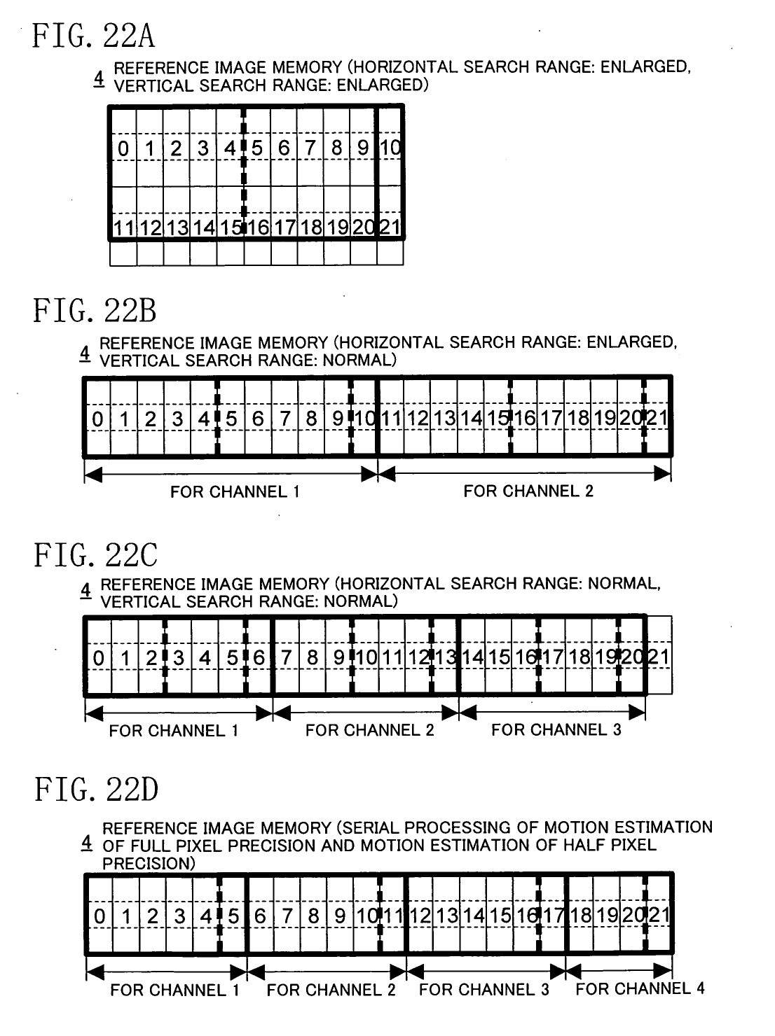

The allocation of reference bank memories in the reference image memory 4 by the search range setting circuit 20 (hereinafter referred to as bank allocation) is illustrated in FIGS. 22A to 22D. FIGS. 22A to 22D illustrate the case where the reference image memory 4 comprises 22 reference bank memories. FIGS. 22A to 22C illustrate the bank allocation of the motion estimation methods described in the first to third examples, i.e., the bank allocation employing the control method in which motion estimation of full pixel precision, motion estimation of half pixel precision, and spare transfer for image data of a reference bank memory for motion estimation with respect to the next target macroblock are performed in parallel. In the bank allocation of FIG. 22C to a normal search range, seven reference bank memories are allocated to each of three channels separately. In the bank allocation of FIG. 22B to a search range enlarged in the horizontal direction, eleven reference bank memories are allocated to each of two channels separately. In the bank allocation of FIG. 22A to a search range enlarged in both the horizontal and vertical directions, all of the 22 reference bank memories are allocated and dedicated to one channel. FIGS. 22B and 22C illustrate the case where the image size PS and the frame rate FR are the same between each channel. However, when the image size PS and the frame rate FR are different between each channel, the number of reference bank memories allocated to a channel having a large image size PS and frame rate FR may be changed to be large.

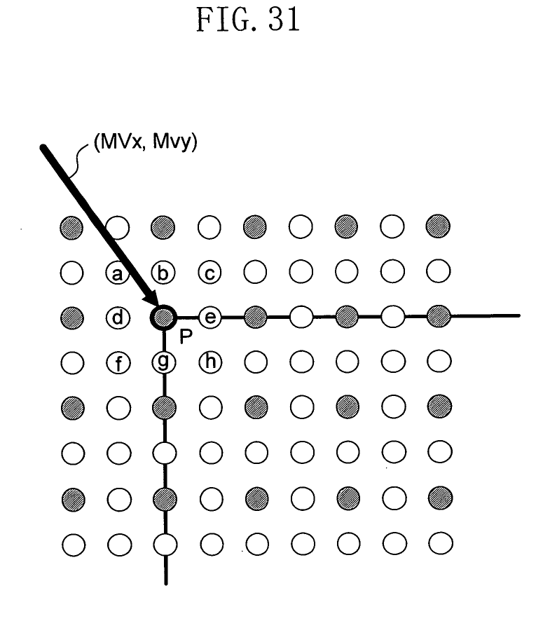

FIG. 22D illustrates bank allocation where the number of channels CN=4. In the first example of the present invention, since the motion estimation method is employed in which motion estimation of full pixel precision, motion estimation of half pixel precision, and spare transfer for image data for motion estimation with respect to the next target macroblock are performed in parallel, the number of reference bank memories per channel needs to be at least seven. Therefore, when the number of channels CN is as large as CN=4, it is difficult to employ the motion estimation method of the present invention under the condition that the number of reference bank memories is 22. Therefore, when the number of channels CN=4 in FIG. 22D, the above-described conventional motion estimation method of FIG. 31 is employed in which motion estimation of full pixel precision and motion estimation of half pixel precision are performed in series. When the number of channels CN=4 in FIG. 22D, six reference bank memories are used for each of three channels, and four reference bank memories are used for the remaining one channel.

Therefore, in this example, a search range is changed, depending on the number of channels to be coded. If the number of channels is small, the search range is enlarged, so that the prediction precision of motion estimation can be improved when a processing time per channel is large. On the other hand, when the number of channels is large, the search range is set to be narrow so that the processing time per channel is limited, thereby making it possible to perform motion estimation with respect to all channels.

### TWELFTH EXAMPLE

Next, a twelfth example will be described. This example is a variation of the network camera of the eleventh example.

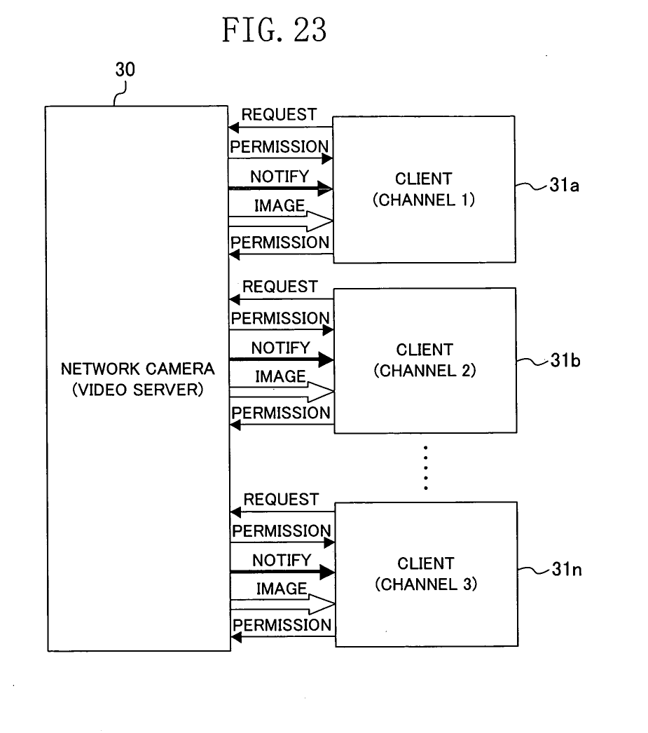

FIG. 23 illustrates a schematic configuration of a system comprising a network camera of this example. In FIG. 23, when there is a request for transmission of an image from any of clients 31a to 31n, a network camera 30 investigates allocation of the reference bank memories in the reference image memory 4. As a result, when there is not a margin of the bank configuration, so that the allocation cannot be changed, a client issuing the transmission request is notified of a message (also referred to as a notification) indicating such matter (a first function), and clients other than the client issuing the transmission request are notified of a message indicating that a reference bank memory of the reference image memory 4 will be allocated to the client issuing the transmission request with priority (second function).

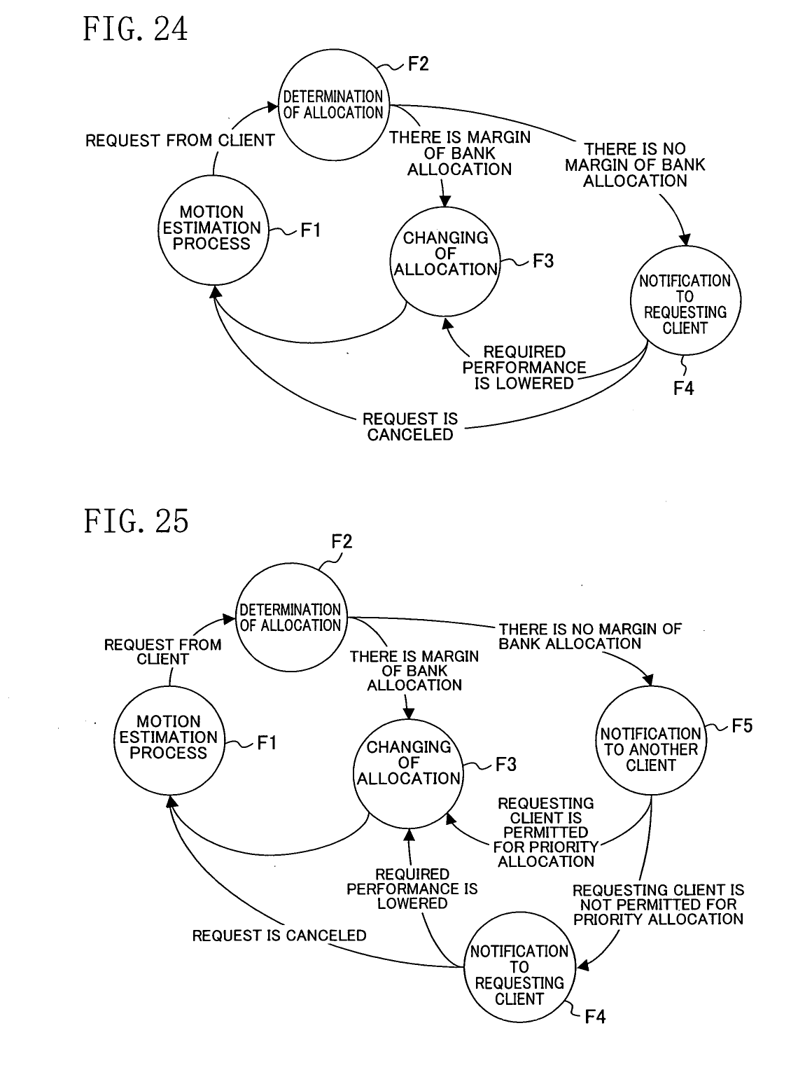

The first function will be described with reference to a state transition diagram of FIG. 24. In FIG. 24, when the network camera 30 receives an image request signal from any of the clients in a state F1 in which the network camera 30 is performing a motion estimation process, the network camera 30 goes to a state F2 in which the network camera 30 determines allocation of a reference bank memory of the reference image memory 4, assuming that the request is accepted. As a result, if there is a margin of the bank configuration, the network camera 30 changes the allocation of a reference bank memory in the reference image memory 4, assuming that the request is accepted, in a state F3. On the other hand, there is not a margin of the bank configuration, the network camera 30 notifies the requesting client issuing the image request signal of a message indicating that matter in a state F4. When the requesting client which has received the message cancels the image request, the network camera 30 returns to the state F1 and continues the past motion estimation process. In this case, when the client changes image performance to be lower than moving image performance firstly requested and issues a request for distribution again, the network camera 30 tries to change the bank configuration in view of the image performance newly requested, and when determining that the allocation can be changed, changes the allocation of a reference bank memory in the reference image memory 4 in the state F3.

Next, the second function will be described with reference to a state transition diagram of FIG. 25. In FIG. 25, a state F5 is provided in addition to the states F1 to F4 of FIG. 24. In the state F5, as a result of the determination of the allocation of a reference bank memory corresponding to the image request from a client in the state F2, when there is not a margin of the bank configuration of the reference image memory 4, clients other than the requesting client are notified of an inquiry of whether or not it is permitted to allocate a reference bank memory to the requesting client issuing the image request with priority. Thereafter, when the other client responds to the inquiry and notifies the network camera 30 of a message indicating that the allocation of a reference bank memory for the requesting client with priority is permitted, the network camera 30 changes the allocation of the reference image memory 4 so that the priority allocation is performed in the state F3. On the other hand, the other client notifies the network camera 30 of a message indicating that the priority allocation is not permitted, the network camera 30 notifies the requesting client of that matter in the state F4.

Therefore, in this example, in a situation in which a network camera is coding an image and is transmitting the coded image data for any of clients, when the network camera receives an image request from another client, there may not be a margin of the bank configuration of the reference image memory 4, and therefore, it may be difficult to transmit an image to the requesting client. Even in this case, if the requesting client issues a distribution request in which the required performance of the image is lowered, or the other client permits allocation of a reference bank memory to the requesting client with priority, the bank allocation of the reference image memory 4 is changed. Therefore, an image is transmitted to a client which issues an image request later to the extent possible, so that images can be transmitted in parallel to a larger number of clients, thereby making it possible to improve performance of a network camera.

### THIRTEENTH EXAMPLE

Next, a thirteenth example of the present invention will be described. This example illustrates an exemplary image capturing system (video system), such as a digital still camera or the like, which utilizes the above-described motion estimating device.

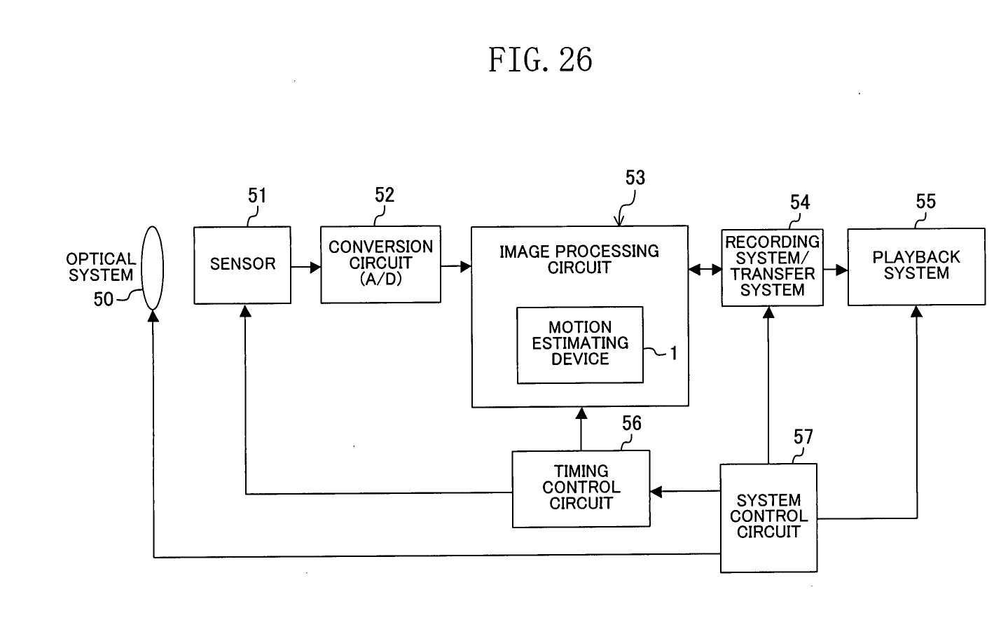

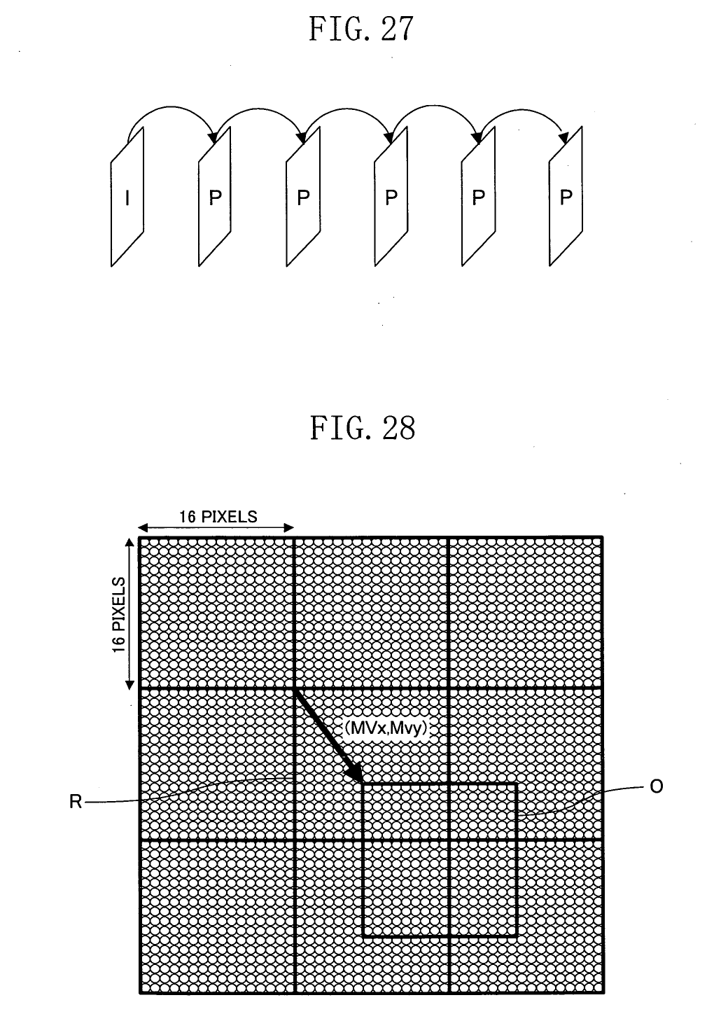

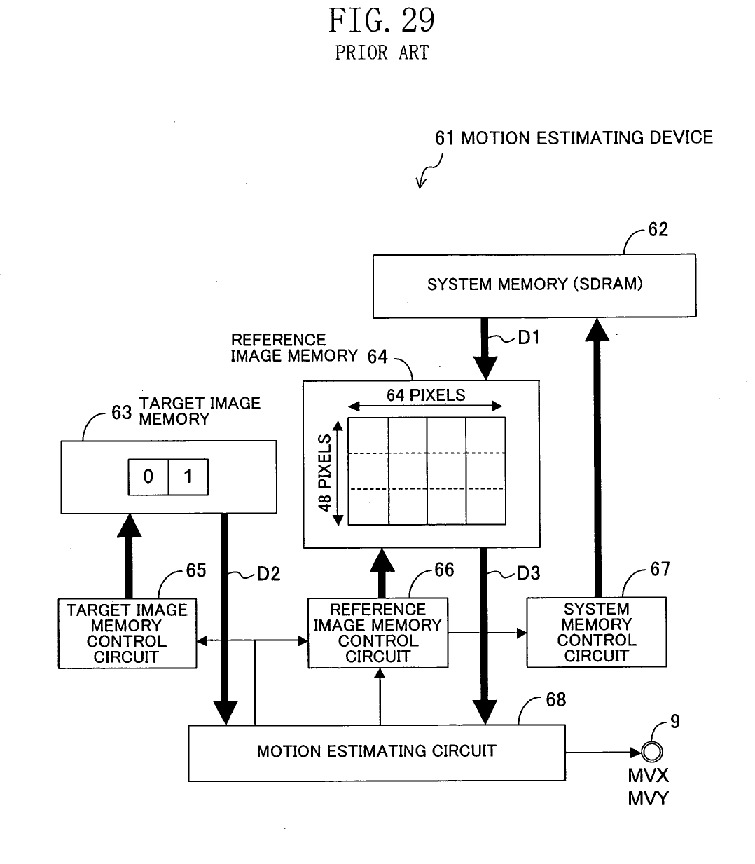

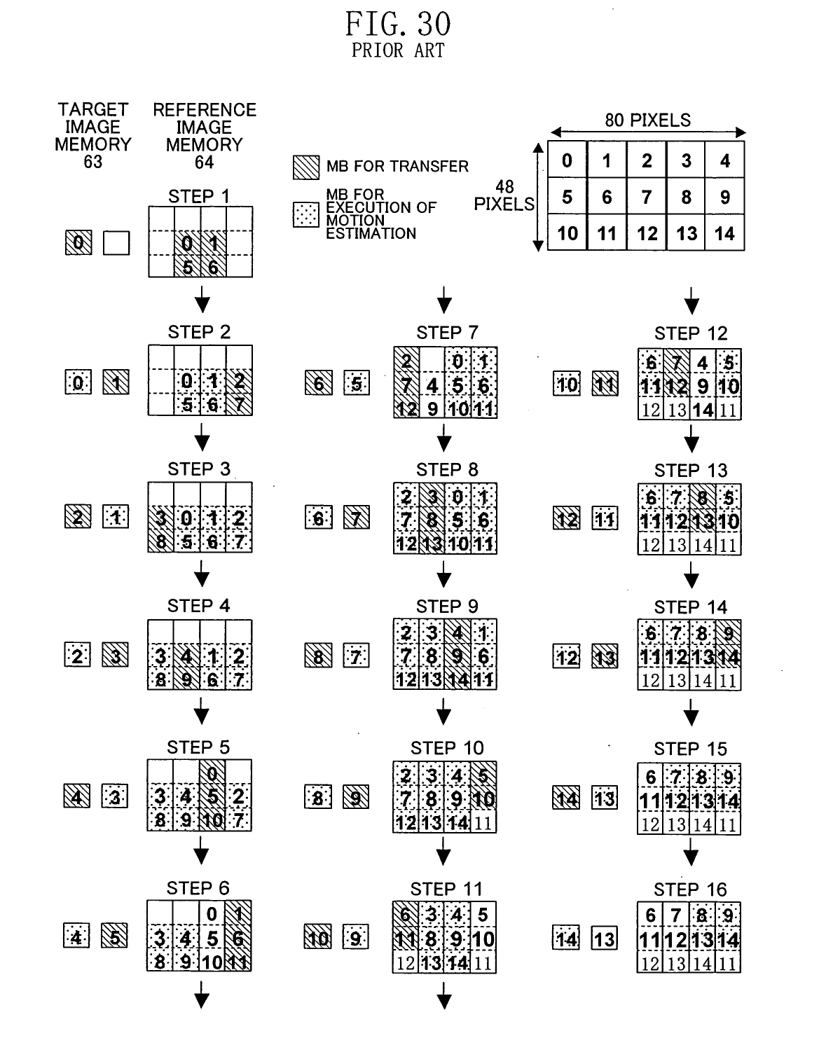

FIG. 26 illustrates the image capturing system of this example. In the image capturing system of FIG. 26, image light entering through an optical system 50 is imaged on a sensor 51, in which the light is in turn subjected to photoelectric conversion. An electrical signal obtained by photoelectric conversion is converted into a digital value by an A/D conversion circuit 52, and thereafter, is input to an image processing circuit 53 including, for example, the motion estimating device 1 of FIG. 1. In the image processing circuit (image processing section) 53, an Y/C process, an edge process, enlargement/reduction of an image, and a compression/decompression process (e.g., JPEG, MPEG, etc.), and the like are performed. The image-processed signal is recorded or transferred into a medium by a recording system/transfer system 54. The recorded or transferred signal is reproduced by a playback system 55. The sensor 51 and the motion estimating device 1 are controlled by a timing control circuit 56. The optical system 50, the recording system/transfer system 54, the playback system 55, and the timing control circuit 56 are each controlled by a system control circuit 57.

Although it has been described that a camera apparatus or the like in which image light entering through the optical system 50 is subjected to photoelectric conversion in the sensor 51, and the resultant electric signal is input to the A/D conversion circuit 52 in the image capturing system of FIG. 26, the present invention is not limited to this. Alternatively, an analog video input of an AV apparatus, such as a television or the like, may be directly input to the A/D conversion circuit 52.

What is claimed is:

1. A signal processing device for estimating a motion of a target macroblock image included in a target frame image by referencing a plurality of reference macroblock images included in a reference frame image, comprising:
a target image storing section for storing the target macroblock image included in the target frame image;
a reference image storing section for storing a plurality of reference macroblock images located in a first direction which is a direction in which the target macroblock image is processed and in a second direction perpendicular to the first direction around a reference macroblock image corresponding to the target macroblock image of the plurality of reference macroblock images included in the reference frame image, and having a plurality of reference bank sections which are physically separately divided areas each including a predetermined number of reference macroblock images located in the second direction; and
a motion estimating section for performing motion estimation with respect to the target macroblock image in the target image storing section by referencing the plurality of reference macroblocks stored in the plurality of reference bank sections of the reference image storing section.

2. The signal processing device of claim 1, wherein the plurality of reference bank sections of the reference image storing section are adaptively allocated to at least:
a full pixel precision reference bank section for storing a plurality of reference macroblock images for performing motion estimation of full pixel precision with respect to a target macroblock image;
a spare transfer reference bank section for storing a plurality of reference macroblock images for the next cycle for performing motion estimation with respect to a target macroblock image in the next cycle of the target macroblock image; and
a half pixel precision reference bank section for storing a plurality of reference macroblock images for performing motion estimation of half pixel precision with respect to a target macroblock image a predetermined number of cycles before the target macroblock image,
wherein all of the reference bank sections included in the reference image storing section and the motion estimating section are connected via respective separate signal lines.

3. The signal processing device of claim 2, further comprising:
a transfer control section for controlling transfer of the plurality of reference macroblock images stored in the plurality of reference bank sections of the reference image storing section,
wherein the transfer control section performs a full/half pixel precision search parallel execution control to store the plurality of reference macroblock images for the next cycle into the spare transfer reference bank section while simultaneously transferring the plurality of reference macroblock images stored in the full pixel precision reference bank section and the plurality of reference macroblock images stored in the half pixel precision reference bank section to the motion estimating section.

4. The signal processing device of claim 3, wherein, instead of the full/half pixel precision search parallel execution control, the transfer control section performs a full/half pixel precision search serial execution control to store the plurality of reference macroblock images for the next cycle into the spare transfer reference bank section, and thereafter, transfer the plurality of reference macroblock images stored in the full pixel precision reference bank section as a plurality of reference macroblock images for half pixel precision to the motion estimating section, while transferring the plurality of reference macroblock images stored in the full pixel precision reference bank section to the motion estimating section.

5. The signal processing device of claim 3, further comprising:
a bank configuration specifying section for specifying the number of reference bank sections used in the reference image storing section as a bank configuration,
wherein the bank configuration specifying section receives information about required image performance, and changes the bank configuration of the reference image storing section, depending on the received required performance, and
the transfer control section switches the full/half pixel precision search parallel execution control and the full/half pixel precision search serial execution control, depending on the bank configuration of the reference image storing section changed by the bank configuration specifying section.

6. The signal processing device of claim 3, further comprising:
a bank configuration specifying section for specifying the number of reference bank sections used in the reference image storing section as a bank configuration,
wherein the bank configuration specifying section receives information about required image performance, and changes the bank configuration of the reference image storing section, depending on the received required performance, and when the received required performance is high, enlarges storage areas of the full pixel precision reference bank section, the spare transfer reference bank section, and the half pixel precision reference bank section.

7. The signal processing device of claim 5, wherein the information about required image performance is image quality of an image.

8. The signal processing device of claim 5, wherein the information about required image performance is a size of an image.

9. The signal processing device of claim 5, wherein the information about required image performance is a frame rate of an image.

10. The signal processing device of claim 3, wherein motion estimation of an image is performed with bidirectional prediction,
the full pixel precision reference bank section, the spare transfer reference bank section, and the half pixel precision reference bank section of the reference image storing section are separated into forward prediction-dedicated sections and backward prediction-dedicated sections, and
reference macroblock images are transferred to the motion estimating section from the forward prediction-dedicated full pixel precision reference bank section, spare transfer reference bank section and half pixel precision reference bank section, and the backward prediction-dedicated full pixel precision reference bank section, spare transfer reference bank section and half pixel precision reference bank section.

11. The signal processing device of claim 1, further comprising:
a prediction precision detecting section for detecting prediction precision of motion estimation in a set range of an image by the motion estimating section; and
a bank configuration specifying section for specifying the number of reference bank sections used in the reference image storing section as a bank configuration,
wherein the bank configuration specifying section changes the bank configuration of the reference image storing section, depending on the prediction precision detected by the prediction precision detecting section, and when the prediction precision is low, increases the number of reference bank sections to be used.

12. The signal processing device of claim 11, wherein the set range of an image is one frame of the image.

13. The signal processing device of claim 12, wherein, depending on prediction precision in one frame of an image detected by the prediction precision detecting section, the bank configuration specifying section changes the number of reference bank sections in the reference image storing section to be used in motion estimation with respect to a frame next to the frame in which the prediction precision has been detected.

14. The signal processing device of claim 11, wherein the set range of an image is one block line in one frame of the image including a plurality of block lines located in the second direction, each block line including a plurality of macroblocks located in the first direction.

15. The signal processing device of claim 14, wherein, depending on prediction precision in one block line of an image detected by the prediction precision detecting section, the bank configuration specifying section changes the number of reference bank sections in the reference image storing section to be used in motion estimation with respect to a block line next to the block line in which the prediction precision has been detected.

16. The signal processing device of claim 1, wherein the motion estimating section calculates a motion vector for each target macroblock image,
the signal processing device further comprises:
a comparison section for comparing the motion vector for each target macroblock image in the set range of an image by the motion estimating section with a reference value; and
a bank configuration specifying section for specifying the number of reference bank sections used in the reference image storing section as a bank configuration, and
the bank configuration specifying section changes the bank configuration of the reference image storing section, depending on a result of the comparison in the comparison section.

17. The signal processing device of claim 16, wherein the comparison section counts the number of motion vectors for target macroblock images exceeding the reference value, and
the bank configuration specifying section, when the count value is larger than or equal to a set value, increases the number of reference bank sections used in the reference image storing section.

18. The signal processing device of claim 16, wherein the set range of an image is one frame of the image.

19. The signal processing device of claim 18, wherein the bank configuration specifying section changes the number of reference bank sections in the reference image storing section to be used in motion estimation with respect to a frame next to the frame including the target macroblock in which the motion vector has been detected, depending on a result of the comparison by the comparison section.

20. The signal processing device of claim 16, wherein the set range of an image is one block line in one frame of the image including a plurality of block lines located in the second direction, each block line including a plurality of macroblocks located in the first direction.

21. The signal processing device of claim 20, wherein, depending on a result of the comparison by the comparison section, the bank configuration specifying section changes the number of reference bank sections in the reference image storing section to be used in motion estimation with respect to a block line next to the block line including the target macroblock in which the motion vector has been detected.

22. The signal processing device of claim 16, wherein the comparison section compares the first direction component and the second direction component of a motion vector of each target macroblock image with a first direction reference value and a second direction reference value, respectively, and
the bank configuration specifying section changes the bank configuration of the reference image storing section, depending on a result of the comparison of the first direction and the second direction in the comparison section.

23. The signal processing device of claim 1, further comprising:
a bank configuration specifying section for specifying the number of reference bank sections used in the reference image storing section as a bank configuration.

24. An image capturing device comprising:
the signal processing device of claim 23; and
an image capturing section for capturing a moving image, and outputting the image signal to the signal processing device,
wherein the image capturing section has a change detecting section for detecting a change in image position when the moving image is captured, and
a portion of the bank configuration specifying section included in the signal processing device is also used as the change detecting section included in the image capturing section.

25. A network system comprising:
a network camera having an image capturing section; and
a plurality of image terminals for requesting distribution of a moving image captured by the image capturing section of the network camera, and each having an image display device for displaying the distributed moving image,
wherein the network camera has the signal processing device of claim 23, and
the bank configuration specifying section included in the signal processing device changes the bank configuration of the reference image storing section, depending on the number of the image terminals which simultaneously issue the request for distribution of the moving image.

26. The network camera system of claim 25, wherein the signal processing device has the transfer control section of claim 3, and
the transfer control section invariably performs the full/half pixel precision search parallel execution control using the bank configuration of the reference image storing section changed by the bank configuration specifying section.

27. The network camera system of claim 25, wherein the signal processing device has the transfer control section of claim 3, and
the transfer control section switches and controls the full/half pixel precision search parallel execution control and the full/half pixel precision search serial execution control, depending on the bank configuration of the reference image storing section changed by the bank configuration specifying section.

28. The network camera system of claim 25, wherein, assuming that while the moving image is distributed to any of the plurality of image terminals, there is a request for distribution of a moving image from another image terminal, when the bank configuration specifying section cannot change the bank configuration of the reference image storing section in response to the request for distribution of the moving image from the other image terminal, the network camera notifies the other image terminal issuing the distribution request of that matter.

29. The network camera system of claim 28, wherein the other image terminal issuing the distribution request, when receiving from the network camera the notification indicating that the bank configuration of the reference image storing section cannot be changed, transmits to the network camera a request for distribution in which required performance of the moving image is lowered, and
the bank configuration specifying section of the signal processing device of the network camera, when receiving from the other image terminal the request for distribution in which rthe equired performance of the moving image is lowered, tries to change the bank configuration of the reference image storing section, depending on the required performance.

30. The network camera system of claim 28, wherein, when the bank configuration specifying section cannot change the bank configuration of the reference image storing section, depending on the request for distribution of the moving image from the other image terminal, the network camera notifies the image terminal which is distributing the moving image of an inquiry of whether or not allocation of the reference bank section to the other image terminal issuing the distribution request with priority is permitted.

31. The network camera system of claim 30, wherein the image terminal which is distributing the moving image responds to the network camera, regarding the inquiry of whether or not allocation of the reference bank section to the other image terminal issuing the distribution request with priority is permitted, and
the network camera performs the priority allocation when receiving, from image terminal which is distributing the moving image, a response which permits the allocation of the reference bank section to the other image terminal issuing the distribution request with priority.

32. A video system comprising:
an image processing section including the signal processing device of claim 1 and for performing image processing;
a sensor for outputting an image signal to the signal processing device of the image processing section; and
an optical system for imaging light onto the sensor.

33. A video system comprising:
an image processing section including the signal processing device of claim 1 and for performing image processing; and
an A/D conversion section for receiving an image signal having an analog value, converting the image signal into a digital value, and outputting the digital value to the signal processing device of the image processing section.

34. A signal processing method for estimating a motion of a target macroblock image included in a target frame image by referencing a plurality of reference macroblock images included in a reference frame image, wherein
the motion estimation includes first motion estimation for estimating a motion of the target macroblock image in units of a full pixel, and second motion estimation for estimating a motion of the target macroblock image in units of a half pixel,
the signal processing method comprises:
a first step of performing the first motion estimation; and
a second step of performing the second motion estimation, and the first step and the second step are performed in parallel.

35. A signal processing device for estimating a motion of a target macroblock image included in a target frame image by referencing a plurality of reference macroblock images included in a reference frame image, wherein
the motion estimation includes first motion estimation for estimating a motion of the target macroblock image in units of a full pixel, and second motion estimation for estimating a motion of the target macroblock image in units of a half pixel,
the signal processing device comprises:
a reference image storing section for storing a plurality of reference macroblock images located in a horizontal direction and a vertical direction around a reference macroblock image corresponding to the target macroblock image of the plurality of reference macroblock images included in the reference frame image; and
a motion estimating section for performing the first motion estimation and the second motion estimation by referencing the plurality of reference macroblocks stored in the reference image storing section, and
the first motion estimation and the second motion estimation are performed in parallel in the motion estimating section.

36. The signal processing device of claim 35, wherein the reference image storing section is a built-in memory provided in the signal processing device.

37. The signal processing device of claim 36, wherein the built-in memory is an SRAM.

38. The signal processing device of claim 35, wherein, when a search range for motion estimation includes n reference image macroblocks in a processing direction, the first motion estimation with respect to an (m+n)-th macroblock and the second motion estimation with respect to an m-th macroblock are performed in parallel.
